(19) United States
(12) Patent Application Publication
(10) Pub. No.: US 2026/0094522 A1
(43) Pub. Date: Apr. 2, 2026

(54) METHOD OF FORMING A DAISY CHAIN CONNECTION

(71) Applicant: Volvo Car Corporation, Göteborg (SE)

(72) Inventors: Zhennan FEI, Göteborg (SE); Pär NILSSON, Mölndal (SE); Carina BJÖRNSSON, Gothenburg (SE); Karl VANÄS, Göteborg (SE)

(73) Assignee: Volvo Car Corporation, Göteborg (SE)

(21) Appl. No.: 18/899,763

(22) Filed: Sep. 27, 2024

(51) Int. Cl. G08G 1/00; G05D 1/246; G05D 1/698; G05D 101/10; G05D 109/10; G05D 111/30; H04W 4/46

(52) U.S. Cl. CPC G08G 1/22; G05D 1/246; G05D 1/6985; H04W 4/46; G05D 2101/10; G05D 2109/10; G05D 2111/30

(57) ABSTRACT

In an aspect, a system is described. The system comprises: a processor storing instructions in non-transitory memory that, when executed, cause the processor to: receive a request from a plurality of vehicles to join a vehicle fleet; extract vehicle information from the request, categorize the plurality of vehicles based on the vehicle information; determine a lead vehicle from the plurality of vehicles based on the categorization of the plurality of vehicles; determine one or more follower vehicles from the plurality of vehicles based on the categorization of the plurality of vehicles; assign an order to each vehicle based on real-time travel path information and the categorization of the plurality of vehicles; communicate a command to the lead vehicle and the one or more follower vehicles to create the vehicle fleet based on the order; and establish a daisy chain connection within the vehicle fleet based on the order.

### FIELD OF INVENTION

This disclosure relates to the field of establishing connections between vehicles. The disclosure is more particularly related to forming a daisy chain connection between vehicles to organize and manage a vehicle fleet.

### BACKGROUND

The problem is that whenever there is a group of cars wanting to travel for an organized road trip, it is difficult to keep track of everyone that is part of the group. This is especially a big problem when other cars, not part of the group, join the chain because of traffic. If more cars enter the chain, drivers will lose eye contact with the cars and will struggle and lose their focus to find the group. Thus, this could be a safety issue. Further, vehicles should establish connections appropriately between them to enable communication between vehicles to join and to maintain a vehicle fleet.

Therefore, there is a need for a system and method of forming a daisy chain connection between vehicles to organize and manage a vehicle fleet.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In an aspect, a system is described. The system comprises: a processor storing instructions in non-transitory memory that, when executed, cause the processor to: receive a request from a plurality of vehicles to join a vehicle fleet; extract vehicle information from the request, wherein the vehicle information comprises at least one of a vehicle model, a vehicle make, a vehicle type, history of vehicle fleet, a vehicle identification number (ID), a vehicle color, a vehicle specification and a vehicle service and maintenance history; categorize the plurality of vehicles based on the vehicle information; determine a lead vehicle from the plurality of vehicles based on the categorization of the plurality of vehicles; determine one or more follower vehicles from the plurality of vehicles based on the categorization of the plurality of vehicles; assign an order to each vehicle based on real-time travel path information and the categorization of the plurality of vehicles; communicate a command to the lead vehicle and the one or more follower vehicles to create the vehicle fleet based on the order; and establish a daisy chain connection within the vehicle fleet based on the order.

In another aspect, a method is described. The method comprises: receiving a request from a plurality of vehicles to join a vehicle fleet; extracting vehicle information from the request, wherein the vehicle information comprises at least one of a vehicle model, a vehicle make, a vehicle type, history of vehicle fleet, a vehicle identification number (ID), a vehicle color, a vehicle specification, and a vehicle service and maintenance history; categorizing the plurality of vehicles based on the vehicle information; determining a lead vehicle from the plurality of vehicles based on the categorization of the plurality of vehicles; determining one or more follower vehicles from the plurality of vehicles based on the categorization of the plurality of vehicles; assigning an order to each vehicle based on real-time travel path information and categorization of the plurality of vehicles; communicating a command to the lead vehicle and the one or more follower vehicles to create the vehicle fleet based on the order; and establishing a daisy chain connection within the vehicle fleet based on the order.

In another aspect, a non-transitory computer readable storage medium is described. The non-transitory computer readable storage medium storing a sequence of instructions, which when executed, causes a processor to perform: receiving a request from a plurality of vehicles to join a vehicle fleet; extracting vehicle information from the request, wherein the vehicle information comprises at least one of a vehicle model, a vehicle make, a vehicle type, history of vehicle fleet; a vehicle identification number (ID), a vehicle color, a vehicle specification, and a vehicle service and maintenance history; categorizing the plurality of vehicles based on the vehicle information; determining a lead vehicle from the plurality of vehicles based on the categorization of the plurality of vehicles; determining one or more follower vehicles from the plurality of vehicles based on the categorization of the plurality of vehicles; assigning an order to each vehicle based on real-time travel path information and categorization of the plurality of vehicles; communicating a command to the lead vehicle and the one or more follower vehicles to create the vehicle fleet based on the order; and establishing a daisy chain connection within the vehicle fleet based on the order.

The methods and systems disclosed herein may be implemented in any means for achieving various aspects and may be executed in a form of a non-transitory machine-readable medium embodying a set of instructions that, when executed by a machine, causes the machine to perform any of the operations disclosed herein. Other features will be apparent from the accompanying drawings and from the detailed description that follows.

### BRIEF DESCRIPTION OF THE FIGURES

These and other aspects of the present disclosure will now be described in more detail, with reference to the appended drawings showing exemplary embodiments, in which:

FIG. 1A illustrates a network diagram of a vehicle group according to an embodiment.

FIG. 1B illustrates a first scenario associated with the vehicle group according to an embodiment.

FIG. 1C illustrates a second scenario associated with the vehicle group according to an embodiment.

FIG. 1D illustrates a third scenario associated with the vehicle group according to an embodiment.

FIG. 2A illustrates a block diagram of a system associated with a vehicle according to an embodiment.

FIG. 2B illustrates a block diagram of electronic components of the vehicle according to an embodiment.

FIG. 3A illustrates a message flow diagram between a lead vehicle and one or more vehicles in the vehicle group according to an embodiment.

FIG. 3B illustrates a message format associated with a communication from the lead vehicle to one or more vehicles in the vehicle group according to an embodiment.

FIG. 3C illustrates a message format associated with a communication from the one or more vehicles in the vehicle group to the lead vehicle according to an embodiment.

FIG. 4 illustrates an example block diagram for an Artificial Intelligence and Machine Learning (AI/ML) model used in a system for maintaining a daisy chain connection according to an embodiment.

FIG. 5A illustrates a structure of the neural network/machine learning model with a feedback loop according to an embodiment.

FIG. 5B illustrates a structure of the neural network/machine learning model with reinforcement learning according to an embodiment.

FIG. 6 illustrates a flow chart describing a method for maintaining a daisy chain connection according to an embodiment.

FIG. 7 illustrates a block diagram of the system implementing the method for maintaining a daisy chain connection according to an embodiment.

FIG. 8 illustrates a block diagram of the method executed by the non-transitory computer-readable medium for maintaining a daisy chain connection according to an embodiment.

FIG. 9 illustrates a flow chart describing a method to connect with a preceding and a succeeding vehicle in the vehicle group according to an embodiment.

FIG. 10 illustrates a block diagram of the system implementing the method to connect with a preceding and a succeeding vehicle in the vehicle group according to an embodiment.

FIG. 11 illustrates a block diagram of the method executed by the non-transitory computer-readable medium for connecting with a preceding and a succeeding vehicle in the vehicle group according to an embodiment.

FIG. 12 illustrates a flow chart describing a method of monitoring and controlling the operations of the vehicle group according to an embodiment.

FIG. 13 illustrates a block diagram of the system implementing the method of monitoring and controlling the operations of the vehicle group according to an embodiment.

FIG. 14 illustrates a block diagram of the method executed by the non-transitory computer-readable medium for monitoring and controlling the operations of the vehicle group according to an embodiment.

FIG. 15A illustrates the block diagram of the cyber security module in view of the system and server according to an embodiment.

FIG. 15B illustrates an embodiment of the cyber security module according to an embodiment.

FIG. 15C illustrates another embodiment of the cyber security module according to an embodiment.

FIG. 16 illustrates a block diagram of a system for maintaining a daisy chain connection according to an embodiment.

FIG. 17 illustrates a system, according to one or more embodiments.

FIG. 18 illustrates a method, according to one or more embodiments.

FIG. 19 illustrates a non-transitory computer readable storage medium, according to one or more embodiments.

FIG. 20 illustrates a pictorial representation of the road infrastructure having virtual place holders, according to one or more embodiments.

FIG. 21 illustrates a request message sent by vehicle, according to one or more embodiments.

FIG. 22 illustrates a road infrastructure having vehicles arranged to form a vehicle fleet, according to one or more embodiments

FIG. 23 illustrates a daisy chain connection, according to one or more embodiments.

FIG. 24 illustrates a routing path information message, according to one or more embodiments.

Other features of the present embodiments will be apparent from the accompanying drawings and from the detailed description that follows.

### DETAILED DESCRIPTION

### Definitions and General Techniques

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denotes the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

No element, act, or instruction used herein should be construed as critical or essential unless explicitly described as such. Also, as used herein, the articles “a” and “an” are intended to include items and may be used interchangeably with “one or more.” Furthermore, as used herein, the term “set” is intended to include items (e.g., related items, unrelated items, a combination of related items, and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The terms “couple,” “coupled,” “couples,” “coupling,” and the like should be broadly understood and refer to connecting two or more elements mechanically and/or otherwise. Two or more electrical elements may be electrically coupled together, but not mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,”and the like does not mean that the coupling, etc. in question is or is not removable.

As used herein, two or more elements or modules are “integral” or “integrated” if they operate functionally together. Two or more elements are “non-integral” if each element can operate functionally independently.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately”can mean within plus or minus one percent of the stated value.

As used herein the term “component” refers to a distinct and identifiable part, element, or unit within a larger system, structure, or entity. It is a building block that serves a specific function or purpose within a more complex whole. Components are often designed to be modular and interchangeable, allowing them to be combined or replaced in various configurations to create or modify systems. Components may be a combination of mechanical, electrical, hardware, firmware, software and/or other engineering elements.

Digital electronic circuitry, or computer software, firmware, or hardware, including the structures, disclosed in this specification and their structural equivalents, or in combinations of one or more of them may realize the implementations and all of the functional operations described in this specification. Implementations may be as one or more computer program products, i.e., one or more modules of computer program instructions encoded on a computer-readable medium for execution by, or to control the operation of, data processing apparatus. The computer-readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including, by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of digital computer. A processor will receive instructions and data from a read-only memory (ROM) or a random-access memory (RAM) or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc. may embed a computer. Computer-readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network, may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship with each other.

Embodiments of the present invention may comprise or utilize a special purpose or general-purpose computer including computer hardware. Embodiments within the scope of the present invention may also include physical and other computer-readable media for carrying or storing computer-executable instructions and/or data structures. Such computer-readable media can be any media accessible by a general purpose or special purpose computer system. Computer-readable media that store computer-executable instructions are physical storage media. Computer-readable media that carry computer-executable instructions are transmission media. Thus, by way of example and not limitation, embodiments of the invention can comprise at least two distinct kinds of computer-readable media: physical computer-readable storage media and transmission computer-readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer-readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer-readable media includes combinations of the above, that enable the transport of electronic data between computer systems and/or modules and/or other electronic devices. The term network may include the Internet, a local area network, a wide area network, or combinations thereof. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the cloud. Cloud refers to servers that are accessed over the Internet, and the software and databases that run on those servers.

Further, upon reaching various computer system components, program code in the form of computer-executable instructions or data structures can be transferred automatically from transmission computer-readable media to physical computer-readable storage media (or vice versa). For example, computer-executable instructions or data structures received over a network or data link can be buffered in RAM within a Network Interface Module (NIC), and then eventually transferred to computer system RAM and/or to less volatile computer-readable physical storage media at a computer system. Thus, computer system components that also (or even primarily) utilize transmission media may include computer-readable physical storage media.

Computer-executable instructions comprise, for example, instructions and data which cause a general-purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer-readable media such as computer memory may practice the methods. In particular, one or more processors execute computer-executable instructions, stored in the computer memory, to perform various functions such as the acts recited in the embodiments.

Those skilled in the art will appreciate that the invention may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, perform tasks, and both may also practice the invention. In a distributed system environment, program modules may be located in both local and remote memory storage devices.

As used herein, the term “Unauthorized access” is when someone gains access to a website, program, server, service, or other system using someone else's account or other methods. For example, if someone kept guessing a password or username for an account that was not theirs until they gained access, it is considered unauthorized access.

As used herein, the term “IoT” stands for Internet of Things which describes the network of physical objects “things” or objects embedded with sensors, software, and other technologies for the purpose of connecting and exchanging data with other devices and systems over the internet.

As used herein “Machine learning” refers to algorithms that give a computer the ability to learn without explicit programming, including algorithms that learn from and make predictions about data. Machine learning techniques include, but are not limited to, support vector machine, artificial neural network (ANN) (also referred to herein as a “neural net”), deep learning neural network, logistic regression, discriminant analysis, random forest, linear regression, rules-based machine learning, Naive Bayes, nearest neighbor, decision tree, decision tree learning, and hidden Markov, etc. For the purposes of clarity, part of a machine learning process can use algorithms such as linear regression or logistic regression. However, using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. The ANN may be featured with a feedback loop to adjust the system output dynamically as it learns from the new data as it becomes available. In machine learning, backpropagation and feedback loops are used to train the Artificial Intelligence/Machine Learning (AI/ML) model improving the model's accuracy and performance over time. Statistical modeling relies on finding relationships between variables (e.g., mathematical equations) to predict an outcome.

As used herein the term “order” refers to a particular arrangement or sequence of things, such as items being organized in a specific way.

As used herein, the term “Data mining” is a process used to turn raw data into useful information. It is the process of analyzing large datasets to uncover hidden patterns, relationships, and insights that can be useful for decision-making and prediction.

As used herein, the term “Data acquisition” is the process of sampling signals that measure real world physical conditions and converting the resulting samples into digital numeric values that a computer manipulates. Data acquisition systems typically convert analog waveforms into digital values for processing. The components of data acquisition systems include sensors to convert physical parameters to electrical signals, signal conditioning circuitry to convert sensor signals into a form that can be converted to digital values, and analog-to-digital converters to convert conditioned sensor signals to digital values. Stand-alone data acquisition systems are often called data loggers.

As used herein, the term “Dashboard” is a type of interface that visualizes particular Key Performance Indicators (KPIs) for a specific goal or process. It is based on data visualization and infographics.

As used herein, a “Database” is a collection of organized information so that it can be easily accessed, managed, and updated. Computer databases typically contain aggregations of data records or files.

As used herein, the term “Data set” (or “Dataset”) is a collection of data. In the case of tabular data, a data set corresponds to one or more database tables, where every column of a table represents a particular variable, and each row corresponds to a given record of the data set in question. The data set lists values for each of the variables, such as height and weight of an object, for each member of the data set. Each value is known as a datum. Data sets can also consist of a collection of documents or files.

As used herein, a “sensor” is a device that detects and measures physical properties from the surrounding environment and converts this information into electrical or digital signals for further processing. Sensors play a crucial role in collecting data for various applications across industries. Sensors may be made of electronic, mechanical, chemical, or other engineering components. Examples include sensors to measure temperature, pressure, humidity, proximity, light, acceleration, orientation etc.

The term “infotainment system” or “in-vehicle infotainment system” (IVI) as used herein refers to a combination of vehicle systems which are used to deliver entertainment and information. In an example, the information may be delivered to the driver and the passengers of a vehicle/occupants through audio/video interfaces, control elements like touch screen displays, button panel, voice commands, and more. Some of the main components of an in-vehicle infotainment systems are integrated head-unit, heads-up display, high-end Digital Signal Processors (DSPs), and Graphics Processing Units (GPUs) to support multiple displays, operating systems, Controller Area Network (CAN), Low-Voltage Differential Signaling (LVDS), and other network protocol support (as per the requirement), connectivity modules, automotive sensors integration, digital instrument cluster, etc.

The term “environment” or “surrounding” as used herein refers to surroundings and the space in which a vehicle is navigating. It refers to dynamic surroundings in which a vehicle is navigating which includes other vehicles, obstacles, pedestrians, lane boundaries, traffic signs and signals, speed limits, potholes, snow, water logging etc.

The term “autonomous mode” as used herein refers to an operating mode which is independent and unsupervised.

The term “vehicle” as used herein refers to a thing used for transporting people or goods. Automobiles, cars, trucks, buses, etc., are examples of vehicles. Further, the vehicle may include electric vehicles (EVs), hybrid electric vehicles (HEVs) such as, without limitations, full hybrid electric vehicles (FHEVs) and mild hybrid electric vehicles (MHEVs), battery electric vehicles (BEVs), plug-in hybrid electric vehicles (PHEVs), and neighborhood electric vehicles (NEVs).

The term “autonomous vehicle” also referred to as self-driving vehicle, driverless vehicle, robotic vehicle as used herein refers to a vehicle incorporating vehicular automation, that is, a vehicle that can sense its environment and move safely with little or no human input. Self-driving vehicles combine a variety of sensors to perceive their surroundings, such as thermographic cameras, Radio Detection and Ranging (RADAR), Light Detection and Ranging (LIDAR), Sound Navigation and Ranging (SONAR), Global Positioning System (GPS), odometry and inertial measurement unit. Control systems are designed for the purpose of interpreting sensor information to identify appropriate navigation paths, as well as obstacles and relevant signage.

The term “communication module” or “communication system” as used herein refers to a system which enables the information exchange between two points. The process of transmission and reception of information is called communication. The elements of communication include but are not limited to a transmitter of information, channel or medium of communication and a receiver of information.

The term “autonomous communication” as used herein comprises communication over a period with minimal supervision under different scenarios and is not solely or completely based on pre-coded scenarios or pre-coded rules or a predefined protocol. Autonomous communication, in general, happens in an independent and an unsupervised manner. In an embodiment, a communication module is enabled for autonomous communication.

The term “communication connection” or “communication network” as used herein refers to a communication link. It refers to a communication channel that connects two or more devices for the purpose of data transmission. It may refer to a physical transmission medium such as a wire, or to a logical connection over a multiplexed medium such as a radio channel in telecommunications and computer networks. A channel is used for the information transfer of, for example, a digital bit stream, from one or several senders to one or several receivers. A channel has a certain capacity for transmitting information, often measured by its bandwidth in Hertz (Hz) or its data rate in bits per second. For example, a Vehicle-to-Vehicle (V2V) communication may wirelessly exchange information about the speed, location and heading of surrounding vehicles. Similarly, a Vehicle-to-Grid (V2G) communication may exchange charge information and further transfer charge from the vehicle to the grid.

The term “communication” as used herein refers to the transmission of information and/or data from one point to another. Communication may be by means of electromagnetic waves. Communication is also a flow of information from one point, known as the source, to another, the receiver. Communication comprises one of the following: transmitting data, instructions, information or a combination of data, instructions, and information. Communication happens between any two communication systems or communicating units. The term communication, herein, includes systems that combine other more specific types of communication, such as: V2I (Vehicle-to-Infrastructure), V2N (Vehicle-to-Network), V2V (Vehicle-to-Vehicle), V2P (Vehicle-to-Pedestrian), V2D (Vehicle-to-Device), V2G (Vehicle-to-Grid), and Vehicle-to-Everything (V2X) communication.

The term “Vehicle-to-Vehicle (V2V) communication” refers to the technology that allows vehicles to broadcast and receive messages. The messages may be omni-directional messages, creating a 360-degree “awareness” of other vehicles in proximity. Vehicles may be equipped with appropriate software (or safety applications) that can use the messages from surrounding vehicles to determine potential crash threats as they develop.

The term “Vehicle-to-Everything (V2X) communication” as used herein refers to transmission of information from a vehicle to any entity that may affect the vehicle, and vice versa. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.).

The term “protocol” as used herein refers to a procedure required to initiate and maintain communication; a formal set of conventions governing the format and relative timing of message exchange between two communications terminals; a set of conventions that govern the interactions of processes, devices, and other components within a system; a set of signaling rules used to convey information or commands between boards connected to the bus; a set of signaling rules used to convey information between agents; a set of semantic and syntactic rules that determine the behavior of entities that interact; a set of rules and formats (semantic and syntactic) that determines the communication behavior of simulation applications; a set of conventions or rules that govern the interactions of processes or applications between communications terminals; a formal set of conventions governing the format and relative timing of message exchange between communications terminals; a set of semantic and syntactic rules that determine the behavior of functional units in achieving meaningful communication; a set of semantic and syntactic rules for exchanging information.

The term “communication protocol” as used herein refers to standardized communication between any two systems. An example communication protocol is a DSRC protocol. The DSRC protocol uses a specific frequency band (e.g., 5.9 GHz (Gigahertz)) and specific message formats (such as the Basic Safety Message, Signal Phase and Timing, and Roadside Alert) to enable communications between vehicles and infrastructure components, such as traffic signals and roadside sensors. DSRC is a standardized protocol, and its specifications are maintained by various organizations, including the Institute of Electrical and Electronics Engineers (IEEE) and Society of Automotive Engineers (SAE) International.

The term “bidirectional communication” as used herein refers to an exchange of data between two components. In an example, the first component can be a vehicle, and the second component can be an infrastructure that is enabled by a system of hardware, software, and firmware. In an example, the second component can be an energy source capable of charging a vehicle battery and accepting charge from the vehicle battery.

The term “alert” or “alert signal” refers to a communication to attract attention. An alert may include visual, tactile, audible alert and a combination of these alerts to warn the user of the vehicle. These alerts allow receivers, such as drivers or occupants, the ability to react and respond quickly.

The term “in communication with” as used herein, refers to any coupling, connection, or interaction using signals to exchange information, message, instruction, command, and/or data, using any system, hardware, software, protocol, or format regardless of whether the exchange occurs wirelessly or over a wired connection.

The term “electronic control unit” (ECU), also known as an “electronic control module”, is usually a module that controls one or more subsystems. Herein, an ECU may be installed in a vehicle or other motor vehicle. It may refer to many ECUs, and can include but not limited to, Engine Control Module (ECM), Powertrain Control Module (PCM), Transmission Control Module (TCM), Brake Control Module (BCM) or Electronic Brake Control Module (EBCM), Central Control Module (CCM), Central Timing Module (CTM), General Electronic Module (GEM), Body Control Module (BCM), and Suspension Control Module (SCM). ECUs together are sometimes referred to collectively as the vehicles'computer or vehicles'central computer and may include separate computers. In an example, the electronic control unit can be an embedded system in automotive electronics. In another example, the electronic control unit is wirelessly coupled with automotive electronics.

The terms “non-transitory computer-readable medium” and “computer-readable medium” include a single medium or multiple media such as a centralized or distributed database, and/or associated caches and servers that store one or more sets of instructions. Further, the terms “non-transitory computer-readable medium” and “computer-readable medium” include any tangible medium that is capable of storing, encoding, or carrying a set of instructions for execution by a processor that, for example, when executed, cause a system to perform any one or more of the methods or operations disclosed herein. As used herein, the term “computer-readable medium” is expressly defined to include any type of computer-readable storage device and/or storage disk and to exclude propagating signals.

The term “Vehicle Data bus” as used herein represents the interface to the vehicle data bus (e.g., Controller Area Network (CAN), Local Interconnect Network (LIN), Ethernet/IP, FlexRay, and Media Oriented Systems Transport (MOST)) that may enable communication between the Vehicle on-board equipment (OBE) and other vehicle systems to support connected vehicle applications.

The term, “handshaking” refers to an exchange of predetermined signals between agents connected by a communications channel to assure each that it is connected to the other (and not to an imposter). This may also include the use of passwords and codes by an operator. Handshaking signals are transmitted back and forth over a communications network to establish a valid connection between two stations. A hardware handshake uses dedicated wires such as the request-to-send (RTS) and clear-to-send (CTS) lines in a Recommended Standard 232 (RS-232) serial transmission. A software handshake sends codes such as “synchronize” (SYN) and “acknowledge” (ACK) in a Transmission Control Protocol/Internet Protocol (TCP/IP) transmission.

The term “computer vision module” or “computer vision system” allows the vehicle to “see” and interpret the world around it. This system uses a combination of cameras, sensors, and other technologies such as Radio Detection and Ranging (RADAR), Light Detection and Ranging (LIDAR), Sound Navigation and Ranging (SONAR), Global Positioning System (GPS), and Machine learning algorithms, etc. to collect visual data about the vehicle's surroundings and to analyze that data in real-time. The computer vision system is designed to perform a range of tasks, including object detection, lane detection, and pedestrian recognition. It uses deep learning algorithms and other machine learning techniques to analyze visual data and make decisions about how to control the vehicle. For example, the computer vision system may use object detection algorithms to identify other vehicles, pedestrians, and obstacles in the vehicle's path. It can then use this information to calculate the vehicle's speed and direction, adjust its trajectory to avoid collisions, and apply the brakes or accelerate as needed. It allows the vehicle to navigate safely and efficiently in a variety of driving conditions.

As used herein, the term “driver” refers to such an occupant, even when that occupant is not actually driving the vehicle but is situated in the vehicle so as to be able to take over control and function as the driver of the vehicle when the vehicle control system hands over control to the occupant or driver or when the vehicle control system is not operating in an autonomous or semi-autonomous mode. The driver is also referred to as an operator of the vehicle.

The term “application server” refers to a server that hosts applications or software that delivers a business application through a communication protocol. An application server framework is a service layer model. It includes software components available to a software developer through an application programming interface. It is system software that resides between the operating system (OS) on one side, the external resources such as a database management system (DBMS), communications and Internet services on another side, and the users'applications on the third side.

The term “cyber security” as used herein refers to application of technologies, processes, and controls to protect systems, networks, programs, devices, and data from cyber-attacks.

The term “cyber security module” as used herein refers to a module comprising application of technologies, processes, and controls to protect systems, networks, programs, devices and data from cyber-attacks and threats. It aims to reduce the risk of cyber-attacks and protect against the unauthorized exploitation of systems, networks, and technologies. It includes, but is not limited to, critical infrastructure security, application security, network security, cloud security, Internet of Things (IoT) security.

The term “encrypt” used herein refers to securing digital data using one or more mathematical techniques, along with a password or “key” used to decrypt the information. It refers to converting information or data into a code, especially to prevent unauthorized access. It may also refer to concealing information or data by converting it into a code. It may also be referred to as cipher, code, encipher, encode. A simple example is representing alphabets with numbers—say, ‘A’ is ‘01’, ‘B’ is ‘02’, and so on. For example, a message like “HELLO” will be encrypted as “0805121215,” and this value will be transmitted over the network to the recipient(s).

The term “decrypt” used herein refers to the process of converting an encrypted message back to its original format. It is generally a reverse process of encryption. It decodes the encrypted information so that only an authorized user can decrypt the data because decryption requires a secret key or password. This term could be used to describe a method of unencrypting the data manually or unencrypting the data using the proper codes or keys.

The term “cyber security threat” used herein refers to any possible malicious attack that seeks to unlawfully access data, disrupt digital operations, or damage information. A malicious act includes but is not limited to damaging data, stealing data, or disrupting digital life in general. Cyber threats include, but are not limited to, malware, spyware, phishing attacks, ransomware, zero-day exploits, trojans, advanced persistent threats, wiper attacks, data manipulation, data destruction, rogue software, malvertising, unpatched software, computer viruses, man-in-the-middle attacks, data breaches, Denial of Service (DoS) attacks, and other attack vectors.

The term “hash value” used herein can be thought of as fingerprints for files. The contents of a file are processed through a cryptographic algorithm, and a unique numerical value, the hash value, is produced that identifies the contents of the file. If the contents are modified in any way, the value of the hash will also change significantly. Example algorithms used to produce hash values: the Message Digest-5 (MD5) algorithm and Secure Hash Algorithm-1 (SHA1).

The term “integrity check” as used herein refers to the checking for accuracy and consistency of system related files, data, etc. It may be performed using checking tools that can detect whether any critical system files have been changed, thus enabling the system administrator to look for unauthorized alteration of the system. For example, data integrity corresponds to the quality of data in the databases and to the level by which users examine data quality, integrity, and reliability. Data integrity checks verify that the data in the database is accurate, and functions as expected within a given application.

The term “alarm” as used herein refers to a trigger when a component in a system or the system fails or does not perform as expected. The system may enter an alarm state when a certain event occurs. An alarm indication signal is a visual signal to indicate the alarm state. For example, when a cyber security threat is detected, a system administrator may be alerted via sound alarm, a message, a glowing LED, a pop-up window, etc. Alarm indication signal may be reported downstream from a detecting device, to prevent adverse situations or cascading effects.

As used herein, the term “cryptographic protocol” is also known as security protocol or encryption protocol. It is an abstract or concrete protocol that performs a security-related function and applies cryptographic methods often as sequences of cryptographic primitives. A protocol describes how the algorithms should be used. A sufficiently detailed protocol includes details about data structures and representations, at which point it can be used to implement multiple, interoperable versions of a program. Cryptographic protocols are widely used for secure application-level data transport. A cryptographic protocol usually incorporates at least some of these aspects: key agreement or establishment, entity authentication, symmetric encryption, and message authentication material construction, secured application-level data transport, non-repudiation methods, secret sharing methods, and secure multi-party computation. Hashing algorithms may be used to verify the integrity of data. Secure Socket Layer (SSL) and Transport Layer Security (TLS), the successor to SSL, are cryptographic protocols that may be used by networking switches to secure data communications over a network.

As used herein, the term “vehicle fleet” refers to a group of vehicles owned or operated by a single organization or entity. This can include cars, trucks, vans, buses, and other types of vehicles, depending on the needs of the organization. Fleets are commonly used by businesses, government agencies, and other institutions to carry out various functions. Vehicle fleet may be a vehicle group.

As used herein, the term “vehicle information” refers to fundamental details about a vehicle that provide essential identification and classification. The vehicle information comprises at least one of a vehicle model, a vehicle make, a vehicle type, history of vehicle fleet, a vehicle identification number (ID), a vehicle color, a vehicle specification, and a vehicle service and maintenance history, etc.

As used herein, the term “follower vehicles” refers to vehicles that receive instructions from the lead vehicle and take part in the vehicle fleet according to the instruction. The follower vehicles are the members of the vehicle fleet.

As used herein, the term “categorize” refers to arranging or classifying items into specific groups based on shared characteristics or criteria.

As used herein, the term “real-time travel path information” refers to live, up-to-date data about the routes and conditions of travel from one location to another. This information can include various elements that help the system make informed decisions and optimize the order in setting up the vehicle fleet.

As used herein, the term “daisy chain connection” refers to configuration where devices or vehicles are connected in series, forming a sequence. In this setup, each device is connected to the next one in line, creating a chain-like arrangement. Daisy chain connection is preferred for signal or power transmission.

As used herein, the term “predefined format” refers to a specific, standardized structure or template that is established in advance for organizing data, content, or information. The predefined format is usually set by guidelines or rules and is used consistently to ensure uniformity, clarity, and ease of use.

As used herein, the term “watermark” refers to faint, often semi-transparent mark, logo, text, or pattern that is embedded into a document, image, or physical item to identify ownership, add branding, or prevent unauthorized use or copying.

As used herein, the term “grade” refers to different meanings depending on the context, but generally, it refers to a level, quality, rank, or score assigned to something based on specific criteria.

As used herein, the term “traffic condition” refers to the current state of road traffic in a particular area, including factors that affect the flow and movement of vehicles. Traffic conditions can vary widely and are influenced by various factors, such as the volume of vehicles, road capacity, weather conditions, accidents, and roadworks.

As used herein, the term “road surface condition” refers to the current state of the road's surface, which can impact vehicle traction, safety, and overall driving experience. These conditions are influenced by various factors such as weather, maintenance, and the type of material used in the road construction.

As used herein, the term “road signs” refers to visual signals placed along roads and highways to provide information, warnings, or instructions to drivers, cyclists, and pedestrians. They are an essential part of traffic management, helping to regulate, warn, and guide traffic to ensure safety and efficiency on the roads. Road signs use standardized shapes, colors, and symbols to convey their messages quickly and clearly, regardless of language.

As used herein, the term “environmental weather condition” refers to the state of the atmosphere at a given time and place, including various elements like temperature, humidity, wind, precipitation, visibility, and atmospheric pressure.

As used herein, the term “routing information” refers to data and instructions used to determine/indicate the best path for transmitting data, traveling from one location to another, or navigating through geographical areas.

As used herein, the term “road infrastructure” refers to physical and organizational elements that make up the road network and support the movement of vehicles and pedestrians. It includes the design, construction, and maintenance of roads, bridges, tunnels, and related facilities.

As used herein, the term “virtual place holders” refers to temporary or symbolic elements used in digital environments to represent or reserve space, content, or functionality until the final content or feature is implemented. They serve as stand-ins or markers during the design, development, or planning stages of a project, helping to ensure structure and functionality.

The embodiments described herein can be directed to one or more of a system, a method, an apparatus, and/or a computer program product at any possible technical detail level of integration. The computer program product can include a computer-readable storage medium (or media) having computer-readable program instructions thereon for causing a processor to carry out aspects of the one or more embodiments described herein.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer-readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The term “vehicle system” or “system of a vehicle” or “system associated with a vehicle” as used herein refers to the vehicle comprising the system described in the current application. The system may be integrated and is a part of the vehicle, for example, a system executing a method on a processor storing instructions in a non-transitory memory of the computer system of the vehicle. The system may be external, but the instructions or method are executed through the vehicle, for example the method being in a cloud but is accessed and executed by the vehicle. The system may be designed for a specific purpose to carry out a certain function or task, for example, transmitting a specific message to a user device. The designed system comprising instructions may also be using existing systems present on the vehicle, for example, a communication system of the vehicle.

The term “vehicle group” as used herein refers to a fleet of vehicles traveling from a common source to a common destination. The vehicle group comprises a lead vehicle and one or more vehicles following the lead vehicle. In an embodiment, each of the vehicles in the vehicle group follows a route determined by the lead vehicle.

The term “lead vehicle” as used herein refers to a vehicle that is configured for monitoring and controlling the operations of the vehicle group/vehicle fleet. The lead vehicle may assign an order to each of the vehicles in the group to follow. The lead vehicle may create a route for traveling from a common source to a common destination. Each vehicle in the vehicle group follows the route created by the lead vehicle.

The term “monitoring” as used herein refers to systematic observation and assessment of a system, process, or environment in real-time or near real-time. It involves the regular collection, analysis, and interpretation of data using various sensors. Monitoring may be continuous or adaptive. In some embodiments, monitoring may be performed on each of the vehicles in the vehicle group to determine if any vehicle in the vehicle group lost communication or connection with the group.

The term “location coordinates” as used herein refers to physical coordinates associated with a vehicle. In an embodiment, the physical coordinates comprise coordinates associated with a global positioning system (GPS).

The term “routing information” refers to the data used to determine the optimal path for a vehicle from one location to another. This information includes details about roads, networks, traffic conditions, turn-by-turn directions, and other relevant factors.

The term “occupant” as used herein refers to one or more people in the vehicle including the driver of the vehicle.

Group travel plays a crucial role in transporting a large number of people from a common source to a common destination. Further, group travel involves a group of vehicles to transport a large number of people from the common source to the common destination. Group travel is more prevalent in situations such as, not limited to, city tour, school/college tour, and evacuating people from a place affected by any natural disaster or military moves. For example, when a group of people want to tour an unknown city, all of them may not fit into a single vehicle and may take multiple vehicles. The occupants of multiple vehicles may intend to stay together to travel around the city to enjoy a great time together and at the same time ensure a safe tour. The multiple vehicles may form a vehicle group where each vehicle keeps track of the other vehicle in the group to reach a destination.

Business Problem: During a group travel, keeping a track of each vehicle in the group gets difficult when external vehicles join a route taken by the group, naturally or coincidentally, or due to traffic conditions, or other conditions leading to safety issues.

Technical Problem: Currently, during the group travel, each driver associated with a following vehicle maintains eye contact with a leading vehicle to follow the route. However, when other vehicles, not part of the group, join the chain because of traffic, the driver may lose eye contact or line of sight with the leading vehicle and may lose focus, on safe driving, to find the group. This could lead to safety issues.

Business Solution: Establishing a daisy chain connection and exchanging information associated with the route and order between each of the vehicles in a vehicle group enables maintaining a connection with the vehicle group under all circumstances.

Technical Solution: In one aspect, the present disclosure discusses a system and method for maintaining a daisy chain connection. The system may create a vehicle group comprising one or more vehicles and determine a lead vehicle. The lead vehicle may monitor and control the operations of the one or more vehicles. When a vehicle loses connection, the system may calculate the location of a destination or the location of a vehicle preceding or succeeding the vehicle that loses connection based on the lead vehicle's location and provide an alternate route for the disconnected vehicle to maintain the connection with the vehicle group. In some embodiments, the alternate route is communicated to other vehicles in the vehicle group.

In an aspect, the present disclosure relates to a system comprising: a processor operatively coupled to a memory storing instructions which on execution cause the processor to: create a vehicle group comprising one or more vehicles; assign an order to each of the vehicles in the vehicle group; share routing information with the each of the vehicles in the vehicle group; determine a lost vehicle in the vehicle group; determine, based on the order, a preceding vehicle and a succeeding vehicle associated with the lost vehicle; and determine an alternate route between the lost vehicle and at least one of the preceding vehicle and the succeeding vehicle.

In another aspect, the present disclosure relates to a method comprising: creating a vehicle group comprising one or more vehicles; assigning an order to each of the vehicles in the vehicle group; sharing a routing information with the each of the vehicles in the vehicle group; determining a lost vehicle in the vehicle group; determining, based on the order, a preceding vehicle and a succeeding vehicle associated with the lost vehicle; and determining an alternate route between the lost vehicle and at least one of the preceding vehicle and the succeeding vehicle.

In one another aspect, the present disclosure relates to a non-transitory computer-readable medium having stored thereon instructions executable by a computer system to perform operations comprising: creating a vehicle group comprising one or more vehicles; assigning an order to each of the vehicles in the vehicle group; sharing a routing information with the each of the vehicles in the vehicle group; determining a lost vehicle in the vehicle group; determining, based on the order, a preceding vehicle and a succeeding vehicle associated with the lost vehicle; and determining an alternate route between the lost vehicle and at least one of the preceding vehicle and the succeeding vehicle.

Technical Result: Providing alternate route to a vehicle to rejoin the vehicle group enables maintaining a daisy chain connection in the vehicle group and the safety of the group travel.

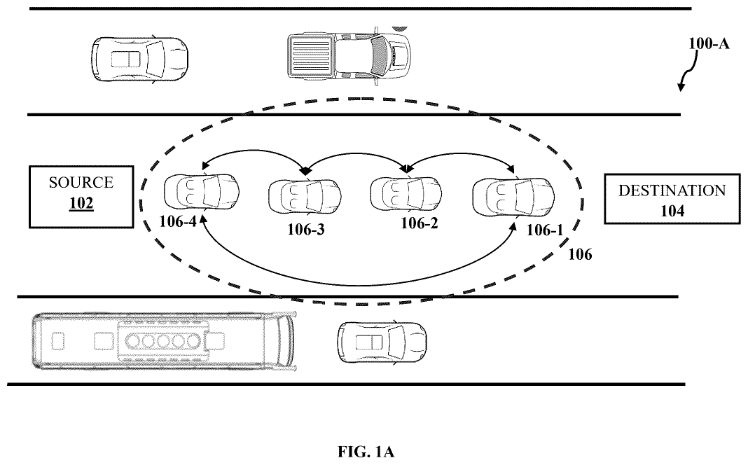

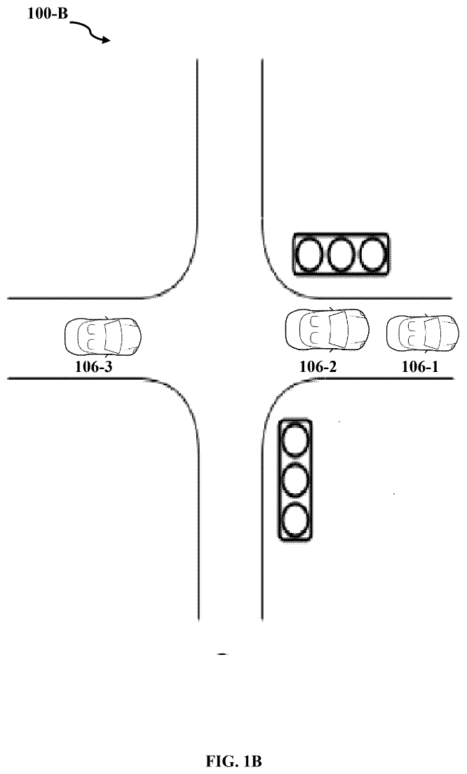

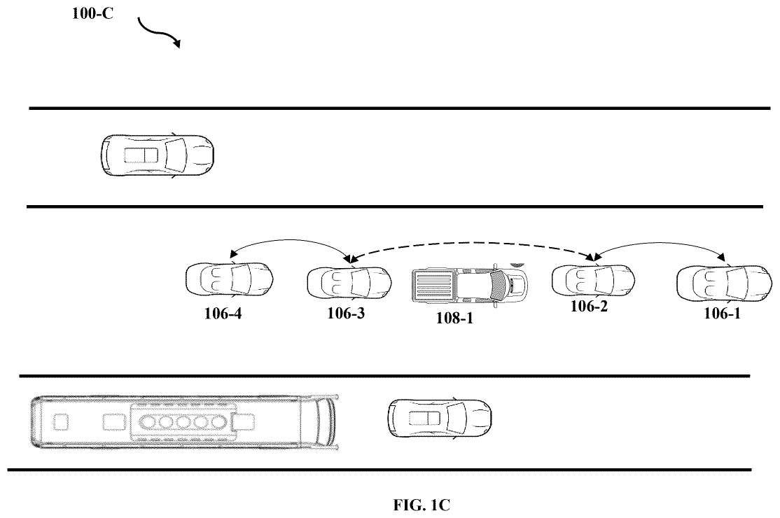

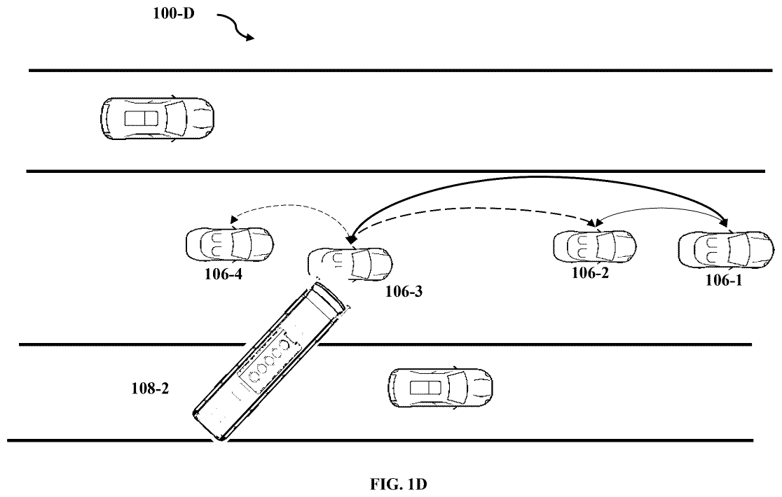

Technical Details Specific to the Technical Solution: FIG. 1A illustrates network diagram 100-A of a vehicle group according to an embodiment.

Referring to FIG. 1A, a group of vehicles 106-1, 106-2, 106-3, 106-4 traveling from source 102 to destination 104 is shown. In some embodiments, vehicles 106-1, 106-2, 106-3, 106-4 traveling from a common source point to a common destination point group together to form vehicle group 106. Further, communication is established between each of the vehicles in vehicle group 106. In some embodiments, each of the vehicles in the vehicle group communicate based on at least one of: an infotainment system, a voice command system, and a communication device associated with the vehicle.

Referring to FIG. 1A, vehicle group 106 comprises a lead vehicle and one or more follower vehicles. In some embodiments, a vehicle from vehicles 106-1, 106-2, 106-3, 106-4 may be designated as a lead vehicle, wherein the lead vehicle is operable to monitor and control the operations of the vehicle group. In an embodiment, the monitoring operations may include the lead vehicle checking for a location of the follower vehicles and determining if the follower vehicles are keeping a track of the vehicle group, i.e., whether the follower vehicles are maintaining connection with the group. The control operations may include the lead vehicle creating a route for the vehicles in the vehicle group to travel and assigning an order to each of the vehicles in the vehicle group to follow. For example, in vehicle group 106, vehicle 106-1 may be designated as the lead vehicle and vehicles 106-2, 106-3, 106-4 may follow the lead vehicle. Lead vehicle 106-1 may create the route that needs to be followed by vehicles 106-2, 106-3, and 106-4 for traveling from source 102 to destination 104. Further, lead vehicle 106-1 may assign an order to each vehicle in vehicle group 106 to follow. Vehicle 106-2 may be assigned order number 1, 106-3 may be assigned order number 2, and 106-4 may be assigned order number 3. Vehicle 106-2 (with order number 1) follows lead vehicle 106-1, vehicle 106-3 (with order number 2) follows vehicle 106-2 (with order number 1), and vehicle 106-4 (with order number 3) follows vehicle 106-3 (with order number 2), thereby creating a daisy chain connection between each of the vehicles in vehicle group 106.

In an embodiment, the lead vehicle is operable to create a vehicle group comprising one or more vehicles, assign an order to each of the vehicles in the vehicle group, establish communication with the each of the vehicles in the vehicle group, and share routing information with the each of the vehicles in the vehicle group. Further, the lead vehicle is operable to determine a lost vehicle in the vehicle group, determine, based on the order, a preceding vehicle and a succeeding vehicle associated with the lost vehicle; and determine an alternate route between the lost vehicle and at least one of the preceding vehicle and the succeeding vehicle to maintain a connection with the vehicle group.

In an embodiment, the routing information comprises a customized route created by the lead vehicle, wherein the customized route is based on a travel plan of the vehicle group.

In an embodiment, the travel plan comprises a common source point and a common destination point, wherein the each of the vehicles in the vehicle group travels from the common source point to the common destination point based on the customized route and based on the assigned order.

In an embodiment, the lead vehicle may share the routing information with the each of the vehicles in the vehicle group. In another embodiment, the lead vehicle may share the routing information with the vehicle immediately following the lead vehicle and instruct the immediately following vehicle to share the routing information with the next vehicle in the vehicle group based on the assigned order. For example, lead vehicle 106-1 may share the routing information with vehicle 106-2, which may further share the routing information with vehicle 106-3.

In an embodiment, a vehicle in the vehicle group may be designated as the lead vehicle based on at least one of a physical location of the vehicle in the vehicle group, information processing capacity associated with the vehicle, and a communication capability of the vehicle.

In an embodiment, a centralized controller operable to control travel of vehicles in group may create a vehicle group comprising one or more vehicles, assign an order to each of the vehicles in the vehicle group, establish communication with the each of the vehicles in the vehicle group, and share routing information with the each of the vehicles in the vehicle group. Further, the centralized controller is operable to determine a lost vehicle in the vehicle group, determine, based on the order, a preceding vehicle and a succeeding vehicle associated with the lost vehicle; and determine an alternate route between the lost vehicle and at least one of the preceding vehicle and the succeeding vehicle.

In an embodiment, the centralized controller may designate a lead vehicle in the vehicle group.

It would be appreciated by a person ordinarily skilled in the art that network 100-A is not restricted to only the components shown in FIG. 1A and may include various other components.

FIGS. 1B-1D illustrate various scenarios associated with a vehicle getting lost or missing connection with a vehicle group.

Referring to FIG. 1B, first scenario 100-B where a vehicle (e.g., vehicle 106-3) getting stuck in a traffic signal and missing connection with the vehicle group is shown. Referring to FIG. 1B, in an example, vehicles 106-1 and 106-2 cross the signal, however, 106-3 gets stuck as the traffic signal turns red. If the traffic signal takes more time to turn green from red, there is a great likelihood for vehicle 106-3 to miss track of vehicles 106-1 and 106-2. In some embodiments, the vehicle that lost connection with the vehicle group (e.g. vehicle 106-3) may send a first message comprising location coordinates associated with its current location to the lead vehicle. Further, the first message may also provide an indication that vehicle 106-3 has lost connection with the group.

In some embodiments, the lead vehicle is operable: to receive a first message from the lost vehicle, wherein the first message comprises location coordinates associated with a current location of the lost vehicle, to estimate a distance between the lost vehicle and at least one of the preceding vehicle and the succeeding vehicle based on the first message, and to generate the alternate route between the lost vehicle and at least one of the preceding vehicle and the succeeding vehicle based on the distance.

In an embodiment, the lead vehicle is operable to communicate the alternate route to at least one of the lost vehicle, the preceding vehicle, and succeeding vehicle.

In some embodiments, if the preceding vehicle is at a shorter distance with the lost vehicle, the lead vehicle may generate the alternate route such that the preceding vehicle waits for the lost vehicle to catch up and thereby, maintain connection with the vehicle group.

In some embodiments, if the succeeding vehicle is at a shorter distance with the lost vehicle the lead vehicle may generate the alternate route such that the lost vehicle waits for the succeeding vehicle to catch up and thereby, maintain connection with the vehicle group. The succeeding vehicle and the lost vehicle may travel together to catch up with the preceding vehicle associated with the lost vehicle.

In an embodiment, the lead vehicle is operable to determine whether a driver associated with the lost vehicle is following the alternate route; and communicate the alternate route to at least one of the preceding vehicle, and succeeding vehicle, based on the driver following the alternate route.

In an embodiment, the alternate route comprises a short-cut and the driver of the lost vehicle may take the short-cut to catch up with at least one of the preceding vehicle or the succeeding vehicle.

In some embodiments, the lead vehicle may continuously ping the each of the vehicles in the vehicle group to determine if any vehicle has lost track of the group. The ping signal may comprise a simple message to check whether the each of the vehicles are tracking the other vehicle in the vehicle group. For example, the lead vehicle may send a “hello vehicle number 2, are you in track with vehicle number 1” message to a second vehicle having an order number 2. The second vehicle may send back a YES/NO response. In an embodiment, if the second vehicle is on track with the first vehicle, it may respond with YES. On the other hand, if the second vehicle has missed the track with the first vehicle, it may respond with NO. The lead vehicle may then determine that the second vehicle has lost connection with the group and proceed to generate the alternate route. In some embodiment, the lead vehicle may get response from the first, second, and third vehicles in the group and determine which of the vehicles lost the connection.

In some embodiments, the first message is associated with at least one of: the lost vehicle being held up at a traffic signal, taking a different turn, missing an exit, losing track of a lane, and being interfered with by an external vehicle crossing the lane, wherein the external vehicle is a vehicle not part of the vehicle group.

In some embodiments, if the lost vehicle is a last vehicle (i.e., vehicle without a succeeding vehicle) in the vehicle group, the last vehicle may communicate the first/second/third message to at least one of the lead vehicle and at least one vehicle preceding the last vehicle. In some embodiment, the last vehicle may generate the alternate route and inform the lead vehicle and the at least one vehicle preceding the last vehicle to maintain a connection with the vehicle group.

FIG. 1C illustrates a second scenario 100-C associated with the vehicle group according to an embodiment.

Referring to FIG. 1C, an external vehicle crossing the lane in between the vehicle group is shown. In some embodiments, when an external vehicle not belonging to the vehicle group intrudes in between, the vehicles in the group lose track of each other. For example, external vehicle 108-1 may enter the lane where the vehicle group is traveling. Vehicle 108-1 may enter between vehicles 106-2 and 106-3 and may make 106-3 lose contact with its preceding vehicle (i.e., 106-2). Vehicle 106-3 may send a message to the lead vehicle that vehicle 106-3 has lost track of vehicle 106-2. The lead vehicle 106-1 may determine the alternate route for the lost vehicle (e.g., vehicle 106-3) and transmit the alternate route to the lost vehicle (e.g., 106-3) and its succeeding vehicle (e.g., 106-4). Based on the alternate route, the lost vehicle and the succeeding vehicle may then join the vehicle group.

In some embodiments, the lead vehicle may determine to create a sub-group comprising the lost vehicle and one or more vehicles succeeding the lost vehicle and may assign a vehicle from the sub-group as a new lead vehicle for the sub-group. Further, the lead vehicle may share the final destination information to the new lead vehicle, wherein the new lead vehicle may determine a travel route for the subgroup and thereby join the main vehicle group.

FIG. 1D illustrates a third scenario 100-D associated with the vehicle group according to an embodiment.

Referring to FIG. 1D, a vehicle in the vehicle group meeting with an accident is shown. In some embodiments, during the travel of the vehicle group at least one of the vehicles may encounter an accident. For example, vehicle 106-3 may collide with another vehicle 108-2 and may send a help or distress signal to lead vehicle 106-1 or the vehicle preceding it 106-2 or succeeding it 106-4 asking for help.

In an embodiment, the lead vehicle may receive a second message from the lost vehicle, wherein the second message comprises a distress signal associated with the lost vehicle 106-3 meeting with an emergency. The lead vehicle is operable to determine, based on the second message, a location of the lost vehicle; and to schedule an emergency help to the lost vehicle based on the location.

In some embodiments, the lead vehicle may connect with emergency help (for example, 911) and transmit the location of the lost vehicle. In some embodiments, the lead vehicle may determine the vehicle succeeding the lost vehicle and instruct the succeeding vehicle 106-4 to assist the lost vehicle by contacting the emergency help.

In some embodiments, if an occupant associated with one of the vehicles in the vehicle group wishes to have a stopover at a particular place, for example, a coffee shop at a geographical location around the travel route or to fill gas or charge vehicle for the further travel, the occupant may communicate the same to the lead vehicle to modify the route for the vehicle group.

In an embodiment, the lead vehicle may receive a third message from the lost vehicle, wherein the third message comprises a stopover plan; and determine modifications to the routing information based on the third message; and share the modified routing information to the each of the vehicles in the vehicle group

In an embodiment, the lead vehicle may receive a request from one or more vehicles to create a vehicle group, create the vehicle group based on the request, obtain location information from each of the vehicles in the vehicle group, assign an order to the each of the vehicles in the vehicle group based on the location information, determine a route for the vehicle group, communicate the order and the route to the each of the vehicles in the vehicle group, and determine an alternate route based on at least one vehicle missing the route.

In some embodiments, vehicles desiring to join the vehicle group, i.e., the follower vehicle, is operable to: transmit a request to join a vehicle group, wherein the vehicle group comprises a lead vehicle and one or more vehicles; receive a response to join the vehicle group; establish communication between the lead vehicle and the one or more vehicles in the vehicle group; receive routing information from the lead vehicle; receive an order associated with moving in the vehicle group; and establish a route with a preceding vehicle and a succeeding vehicle in the vehicle group based on the received order and the routing information.

In an embodiment, the follower vehicle is operable to: determine a loss of established route; and generate an alternate route with at least one of the preceding vehicle and the succeeding vehicle. In an embodiment, the follower vehicle is operable to: communicate the alternate route to at least one of the lead vehicle, the preceding vehicle, and the succeeding vehicle; and rejoin the vehicle group based on the alternate route.

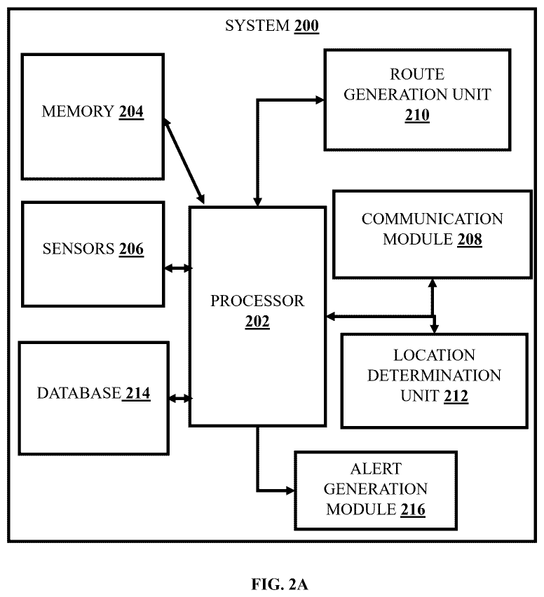

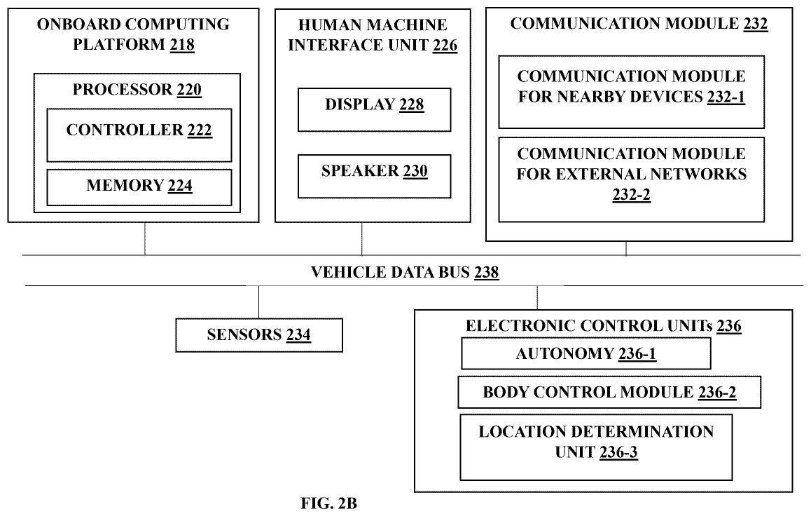

FIG. 2A illustrates a block diagram of a system associated with a vehicle according to an embodiment.

In some embodiments, the system associated with the vehicle maintains a daisy chain connection in a vehicle group. In an embodiment, the system may be placed within the vehicle, wherein the vehicle comprises the lead vehicle. In another embodiment, the system may be placed within the vehicle, wherein the vehicle comprises follower vehicle. In some embodiments, the system may be a centralized controller monitoring and controlling the operations associated with maintaining the daisy chain connection.

System 200 comprises processor 202, memory 204, sensors 206, communication module 208, route generation unit 210, location determination unit 212, database 214, and alert generation module 216.

Referring to FIG. 2A, processor 202 may be a high-performance, multi-core CPU or system-on-chip (SoC) solution to process vast amounts of data. In some embodiments, processor 202 processes data from location determination unit 212 and communication module 208 and other inputs to make real-time decisions related to generating an alternate route for maintaining connection with the vehicle group. Processor 202 may comprise Graphics Processing Units (GPUs). GPUs are utilized for their ability to accelerate tasks like image and sensor data processing. Some vehicles may incorporate Field-Programmable Gate Arrays (FPGAs) to efficiently perform specialized computations, while others might leverage Application-Specific Integrated Circuits (ASICs) for optimized functions. The choice of processor depends on factors such as the vehicle's level of autonomy, processing requirements, power consumption, and thermal considerations. Processors, also known as central processing units (CPUs), are the heart and brain of any computer or electronic device capable of executing instructions. Processor or processors'function is to process data and perform calculations, etc. At the core of their operation lies data processing, where they handle arithmetic and logical operations on data stored in memory. CPUs execute instructions, which are sets of specific operations encoded in machine language, to perform various tasks. The control unit within, or interacting with, the processor manages and coordinates the execution of instructions, fetching them from memory, decoding them, and directing the appropriate components to execute the instruction. To ensure a controlled and orderly flow of tasks, processors use an internal clock that generates regular electrical pulses, synchronizing their operations through clock cycles. Processors support multitasking environments, rapidly switching between executing different tasks for various applications. Additionally, they may work with the operating system to manage virtual memory, allowing programs to access more memory than is physically available, and to efficiently manage memory usage. Processor or processors may be integrated with security features, including hardware-level encryption, memory protection, and support for secure execution environments, enhancing the system's security against potential threats. The processor may run sophisticated algorithms and artificial intelligence (AI) software to analyze sensor data, determine conditions associated with the vehicle and a user of the vehicle, interpret the environment, and help in decision making. Its high-performance capabilities and parallel processing help ensure the vehicle can perceive and respond to its surroundings quickly and accurately. In an embodiment, the processor may be a neuromorphic processor, inspired by the human brain, which offers a unique approach to handling AI tasks. Processor 202 interacts and exchanges data with one or more of the other components or modules of the system, for example, memory 204, sensors 206, communication module 208, route generation unit 210, location determination unit 212, database 214, and alert generation module 216.

Referring to FIG. 2A, memory 204 may be a non-volatile memory (NVM) which is utilized in reliable operations of the system, ensuring that data is preserved even during power interruptions or failures. Various NVM technologies are utilized, such as flash memory for storing the operating system and software, EEPROM for retaining configuration data, calibration values, and sensor settings, Ferroelectric RAM (FRAM) for critical real-time information, and emerging technologies like ReRAM for potential performance enhancements due to its high-speed operation and low power consumption. In an embodiment, the memory may be a cloud-based memory. In another embodiment, the memory may be a local memory. In another embodiment, it may be a combination of local and cloud-based memory. Local memory refers to the traditional memory components present in a physical device, such as a computer's RAM, hard disk drives (HDDs), or solid-state drives (SSDs). It provides fast access to data and is directly connected to the device, making it suitable for immediate processing tasks and offline use. On the other hand, cloud-based memory relies on remote servers and services provided by third-party cloud providers to store and manage data over the internet. Systems can access their data from anywhere with an internet connection, allowing for seamless collaboration and scalability. Cloud-based memory is often used for storing large amounts of data, enabling data sharing, and providing backup and disaster recovery solutions. The combination of local memory and cloud-based memory allows for flexible and efficient data management tailored to different needs of the system.

Referring to FIG. 2A, sensors 206 may comprise various sensors such as a temperature sensor, ultrasonic sensors, LIDAR sensors, radar sensors, camera-based sensors, Infrared (IR) sensors, radio frequency identification (RFID) sensors, etc. Sensors, for example, including cameras, LIDARs, radars, and ultrasonic sensors enable autonomous vehicles to detect and recognize objects, obstacles, and pedestrians on the road to enable navigation of the autonomous vehicles. In some embodiments, communication module 208 facilitates communication between different modules within system 200, communication between the vehicle and other devices, other vehicles, and other infrastructure components, for example, a centralized server.

Referring to FIG. 2A, in some embodiments, database 214 may store data associated with various sensors 206, route generation unit 210, and location determination unit 212. In some embodiments, database 214 may be locally present in system 200 or may be present in a server associated with a manufacturer of the vehicle or in a cloud server. Processor 202 may fetch the data from the database to determine a vehicle order and a route information and establish a route or connection with a preceding vehicle and a succeeding vehicle.

Referring to FIG. 2A, communication module 208, route generation unit 210, and location determination unit 212 are coupled to processor 202. Communication module 208 is operable to communicate with other vehicles or a centralized server and receive information related to the vehicle group, a travel route associated with the vehicle group, and an order of vehicle to be followed while traveling in the group. In some embodiments, communication module 208 establishes communication with each of the vehicles in the vehicle group to receive routing information, assigned vehicle order, and an alternate route to maintain connection with the vehicle group. In some embodiments, the communication module obtains from a lead vehicle the routing information, assigned vehicle order, and the alternate route. In some embodiments, the communication module obtains from at least one of the preceding or the succeeding vehicle the routing information, assigned vehicle order, and the alternate route.

In some embodiments, route generation unit 210 is communicatively coupled to processor 202. Processor 202 is operable to receive, through the communication module, route information associated with the vehicle group and the assigned order of at least one vehicle in the vehicle group. Further, the processor is operable to receive, from the location determination unit, coordinates associated with the location of the at least one vehicle. The processor is operable to determine if the at least one vehicle lost connection (e.g. lost track of the route) with the vehicle group and generate an alternate route for the at least one vehicle to rejoin the vehicle group. In some embodiments, processor 202 communicates with route generation unit 210 to generate the alternate route.

In some embodiments, processor 202 is operable to receive a first message from a lost vehicle, i.e., the at least one vehicle that lost the connection with the vehicle group, wherein the first message comprises location coordinates associated with a current location of the lost vehicle.

In some embodiments, processor 202 is operable to estimate a distance between the lost vehicle and at least one of the preceding vehicle and the succeeding vehicle based on the first message; and generate the alternate route between the lost vehicle and at least one of the preceding vehicle and the succeeding vehicle based on the distance.

In some embodiments, processor 202 is operable to communicate the alternate route to at least one of the lead vehicle, the preceding vehicle, and succeeding vehicle.

In some embodiments, processor 202 is operable to communicate the alternate route to a driver associated with the lost vehicle, determine whether the driver is following the alternate route; and communicate the alternate route to at least one of the lead vehicle, the preceding vehicle, and succeeding vehicle, based on the driver following the alternate route.

In some embodiments, processor 202 is operable to receive a second message from the lost vehicle, wherein the second message comprises a distress signal associated with the lost vehicle meeting with an emergency. In some embodiments, the distress signal may include at least an audio or a visual indication or any signal indicating distress generated by alert generation module 216.

In some embodiments, processor 202 is operable to determine, based on the second message, a location of the lost vehicle; and schedule an emergency help to the lost vehicle based on the location.

In some embodiments, processor 202 is operable to: receive a third message from the lost vehicle, wherein the third message comprises a stopover plan; determine modifications to the routing information based on the third message; and share the modified routing information to the each of the vehicles in the vehicle group.

In some embodiments, processor 202 is operable to transmit, through the communication module, a request to join the vehicle group, and receive, through the communication module, a response to join the vehicle group.

It would be appreciated by a person ordinarily skilled in the art that system 200 is not limited to the components mentioned and may include more components based on the functional needs of the system. Further, the modules mentioned in the system may be software based, hardware based, or a combination of hardware and software. The modules may be communicatively and operatively coupled to one another and with processor 202.

FIG. 2B illustrates a block diagram of various electronic components of the vehicle according to an embodiment.

Referring to FIG. 2B, the vehicle comprising various electronic components, such as, onboard computing platform 218, human-machine interface (HMI) unit 226, communication module 232, sensors 234, electronic control units (ECUs) 236, and vehicle data bus 238, is shown. FIG. 2B illustrates an example architecture of some of the electronic components, as shown in FIG. 2A. Onboard computing platform 218 comprises processor 220 (also referred to as a microcontroller unit or a controller) and memory 224. In the illustrated example, processor 220 of the onboard computing platform is structured to comprise controller 222. In other examples, controller 222 is incorporated into another ECU with its own processor and memory. The processor may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, memory 224 comprises multiple kinds of memory, particularly volatile memory, and non-volatile memory. Memory 224 is computer-readable media on which one or more sets of instructions, such as the software for operating the methods of the present disclosure, can be embedded. The instructions may embody one or more of the methods or logic as described herein. For example, the instructions reside completely, or at least partially, within any one or more of the memory 224, the computer-readable medium, and/or within processor 220 during execution of the instructions.

HMI unit 226 provides an interface between the vehicle and a user. HMI unit 226 comprises digital and/or analog interfaces (e.g., input devices and output devices) to receive input from, and display information for, the user(s). The input devices comprise, for example, a control knob, an instrument panel, a digital camera for image capture and/or visual command recognition, a touch screen, an audio input device (e.g., cabin microphone), buttons, or a touchpad. The output devices may comprise instrument cluster outputs (e.g., dials, lighting devices), haptic devices, actuators, display 228 (e.g., a heads-up display, a center console display such as a liquid crystal display (LCD), an organic light emitting diode (OLED) display, a flat panel display, a solid-state display, etc.), and/or speaker 230. For example, the display, the speaker, and/or other input and output device(s) of HMI unit 226 are operable to emit an alert, such as an alert to request manual takeover to an operator (e.g., a driver) of the vehicle. Further, the HMI unit of the illustrated example comprises hardware (e.g., a processor or controller, memory, storage, etc.) and software (e.g., an operating system, etc.) for an infotainment system that is presented via display 228.

In some embodiments, the driver associated with each of the vehicles in the vehicle group may select the HMI to communicate with other vehicles in the vehicle group. Communication may be established using a vehicle infotainment system or an audio input device (e.g., voice command from the driver). In some embodiments, the route information, such as a map may be displayed on display 228. In some embodiments, the route information may be given as a commentary on speaker 230.

Sensors 234 are arranged in and/or around the vehicle to monitor the interior regions of the vehicle and/or an environment in which the vehicle is driving. One or more of the sensors may be mounted to measure various parameters around an exterior of the vehicle. Additionally, or alternatively, one or more of sensors may be mounted inside a cabin of the vehicle or in a body of the vehicle (e.g., an engine compartment, wheel wells, etc.) to measure properties of the vehicle and/or interior sensing of the vehicle. For example, sensors 234 comprise accelerometers, odometers, tachometers, pitch and yaw sensors, wheel speed sensors, microphones, tire pressure sensors, biometric sensors, ultrasonic sensors, infrared sensors, Light Detection and Ranging (LIDAR/lidar), Radio Detection and Ranging System (radar), Global Positioning System (GPS), millimeter wave (mmWave) sensors, cameras and/or sensors of any other suitable type. According to an embodiment of the system, the one or more sensors associated with the vehicle comprises camera-based sensors or a camera coupled with a computer vision system.

Referring to FIG. 2B, ECUs 236 monitor and control the subsystems of the vehicle. For example, ECUs 236 are discrete sets of electronics that comprise their own circuit(s) (e.g., integrated circuits, microprocessors, memory, storage, etc.) and firmware, sensors, actuators, and/or mounting hardware. ECUs 236 communicate and exchange information via vehicle data bus 238. Additionally, the ECUs may communicate properties (e.g., status of the ECUs, sensor readings, control state, error, and diagnostic codes, etc.) and/or receive requests from each other. For example, the vehicle may have many ECUs that are positioned in various locations around the vehicle and are communicatively coupled by the vehicle data bus.

In the illustrated example, ECUs 236 comprise autonomy unit 236-1, body control module 236-2, and location determination unit 236-3. For example, autonomy unit 236-1 is operable to perform autonomous and/or semi-autonomous driving maneuvers (e.g., defensive driving maneuvers) of the vehicle based upon, at least in part, instructions received from controller 222 and/or data collected by sensors 234 (e.g., object detection sensors). Further, body control module 236-2 controls one or more subsystems throughout the vehicle, such as power windows, power locks, an immobilizer system, power mirrors, etc. For example, body control module 236-2 comprises circuits that drive one or more relays (e.g., to control wiper fluid, etc.), brushed direct current (DC) motors (e.g., to control power seats, power locks, power windows, wipers, etc.), stepper motors, LEDs, safety systems (e.g., seatbelt pretensioner, air bags, etc.), etc. For example, location determination unit 236-3 (similar to location determination unit 212 of FIG. 2A) is operable to determine GPS coordinates associated with a physical location of the vehicle to the processor. The processor determines whether the vehicle lost connection with the vehicle group and generates an alternate route for the vehicle to maintain connection with the vehicle group.

Referring to FIG. 2B, vehicle data bus 238 communicatively couples communication module 232, onboard computing platform 218, HMI unit 226, sensors 234, and ECUs 236. In some examples, vehicle data bus 238 comprises one or more data buses. Vehicle data bus 238 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

Referring to FIG. 2B, communication module 232 may comprise a near field communication module or a communication module for nearby device 232-1 and far field communication module or communication module for external network 232-2. Communication module for nearby devices 232-1 is operable to communicate with other nearby communication devices. In an example, communication module 232 comprises a dedicated short-range communication (DSRC) module. A DSRC module comprises antenna(s), radio(s) and software to communicate with nearby vehicle(s) via vehicle-to-vehicle (V2V) communication, infrastructure-based module(s) via vehicle-to-infrastructure (V2I) communication, and/or, more generally, nearby communication device(s) (e.g., a mobile device-based module) via vehicle-to-everything (V2X) communication. V2V communication allows vehicles to share information such as speed, position, direction, route, order, and other relevant data, enabling them to cooperate and coordinate their actions to improve safety, efficiency, and mobility on the road. It may rely on dedicated short-range communication (DSRC) and other wireless protocols that enable fast and reliable data transmission between vehicles. V2V communication, which is a form of wireless communication between vehicles, allows vehicles to exchange information and coordinate with other vehicles on the road.

Additionally, or alternatively, communication module for external networks 232-2 comprises a cellular vehicle-to-everything (C-V2X) module. A C-V2X module comprises hardware and software to communicate with other vehicle(s) via V2V communication, infrastructure-based module(s) via V2I communication, and/or, more generally, nearby communication devices (e.g., mobile device-based modules) via V2X communication. For example, a C-V2X module is operable to communicate with nearby devices (e.g., vehicles, roadside units, mobile devices of users, etc.) directly and/or via cellular networks. Currently, standards related to C-V2X communication are being developed by the 3^{rd} Generation Partnership Project. Further, communication module 232-2 is operable to communicate with external networks. For example, communication module 232-2 comprises hardware (e.g., processors, memory, storage, antenna, etc.) and software to control wired or wireless network interfaces. In the illustrated example, the communication module 232-2 comprises one or more communication controllers for wireless networks, satellite communication network, microwave communication network, fiber optic communication network, cellular networks (e.g., Global System for Mobile Communications (GSM), Universal Mobile Telecommunications System (UMTS), Long Term Evolution (LTE), Code Division Multiple Access (CDMA)), fifth generation 5G networks, Near Field Communication (NFC) and/or other standards-based networks (e.g., WiMAX (IEEE 802.16m), local area wireless network (including IEEE 802.11 a/b/g/n/ac or others), Wireless Gigabit (IEEE 802.11ad), etc.). In some examples, the communication module for external networks 232-2 comprises a wired or wireless interface (e.g., an auxiliary port, a Universal Serial Bus (USB) port, a Bluetooth® wireless node, etc.) to communicatively couple with a mobile device (e.g., a smart phone, a wearable, a smart watch, a tablet, etc.). In such examples, the vehicle may communicate with the external network via the coupled mobile device. The external network(s) may be a public network, such as the Internet, a private network, such as an intranet, or combinations thereof, and may utilize a variety of networking protocols now available or later developed including, but not limited to, TCP/IP-based networking protocols.

The communication module comprises a hardware component comprising, a vehicle gateway system comprising a microcontroller, a transceiver, a power management integrated circuit, an Internet of Things device capable of transmitting one of an analog and a digital signal over one of a telephone, a communication, either wired or wirelessly.

Autonomy unit 236-1 of the illustrated example is operable to perform autonomous and/or semi-autonomous driving maneuvers, such as defensive driving maneuvers, for the vehicle. For example, autonomy unit 236-1 performs the autonomous and/or semi-autonomous driving maneuvers based on data collected by sensors 234. In some examples, autonomy unit 236-1 is operable to operate a fully autonomous system, a park-assist system, an advanced driver-assistance system (ADAS), and/or other autonomous system(s) for the vehicle.

Further, in the illustrated example, the controller (or control module) is operable to monitor an ambient environment of the vehicle. For example, to enable autonomy unit 236-1 to perform autonomous and/or semi-autonomous driving maneuvers, the controller collects data that is collected by sensors 234 of the vehicle. In some examples, the controller collects location-based data via communication module 232-1 and/or another module (e.g., a GPS receiver) to facilitate the autonomy unit in performing autonomous and/or semi-autonomous driving maneuvers. Additionally, the controller collects data from (i) adjacent vehicle(s) via communication module 232-1 and V2V communication and/or (ii) roadside unit(s) via communication module 232-1 and V2I communication to further facilitate autonomy unit 236-1 in performing autonomous and/or semi-autonomous driving maneuvers.

According to an embodiment, the communication module supports a communication protocol, wherein the communication protocol comprises at least one of an Advanced Message Queuing Protocol (AMQP), Message Queuing Telemetry Transport (MQTT) protocol, Simple (or Streaming) Text Oriented Message Protocol (STOMP), Zigbee protocol, Unified Diagnostic Services (UDS) protocol, Open Diagnostic eXchange format (ODX) protocol, Diagnostics Over Internet Protocol (DoIP), On-Board Diagnostics (OBD) protocol, and a predefined protocol standard.

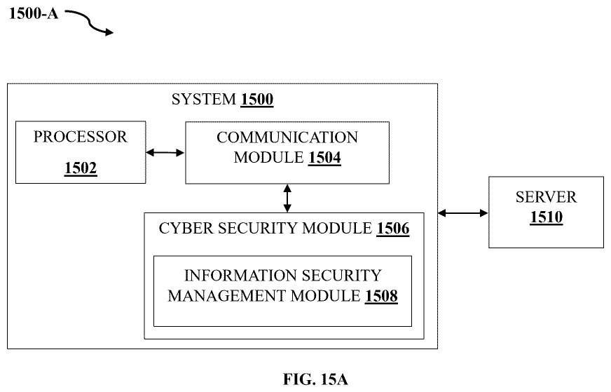

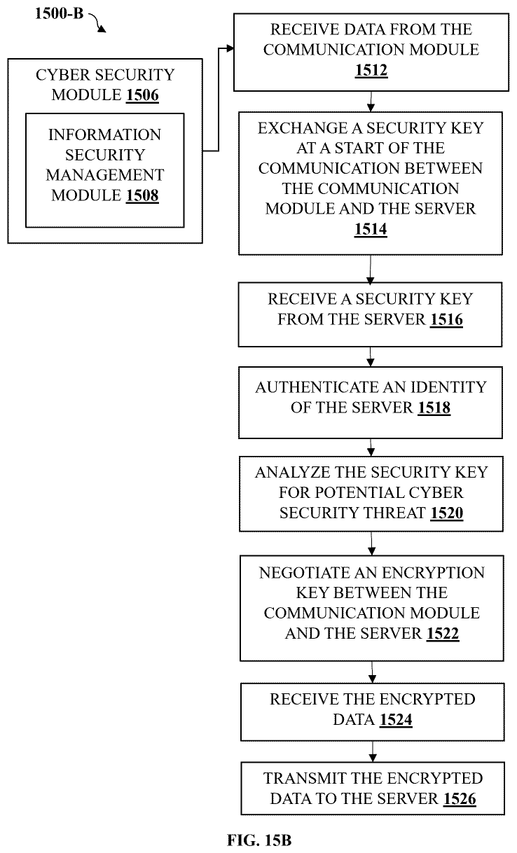

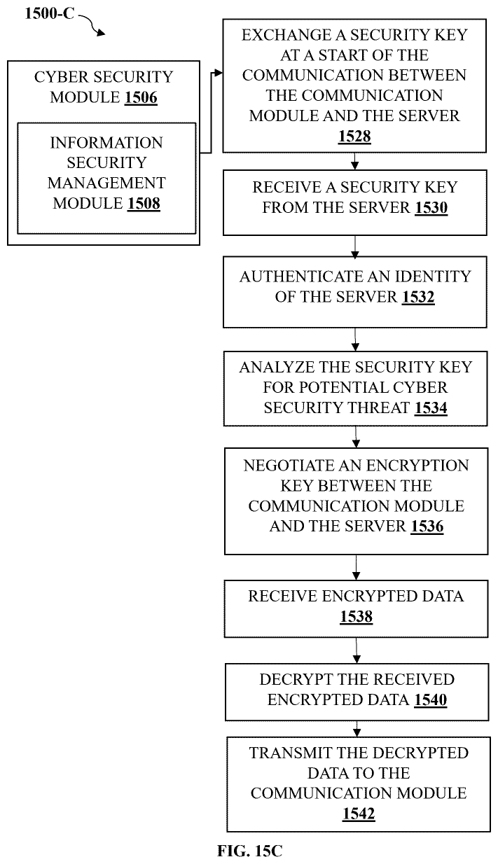

In an embodiment, communication module 232 may comprise a cyber security module 1506 (shown in FIG. 15A). In some embodiments, communication module 232 may communicate with cyber security module 1506 to perform secure communication with nearby devices and external networks. In one aspect, a secure communication management (SCMT) computer device for providing secure data connections is provided. The SCMT computer device comprises a processor in communication with memory. The processor is programmed to receive, from a first device, a first data message. The first data message is in a standardized data format. The processor is also programmed to analyze the first data message for potential cyber security threats. If the determination is that the first data message does not contain a cyber security threat, the processor is further programmed to convert the first data message into a first data format associated with the vehicle environment and transmit the converted first data message to the vehicle system using a first communication protocol associated with the vehicle system. According to an embodiment, secure authentication for data transmissions comprises, provisioning a hardware-based security engine (HSE) located in communication modules, said HSE having been manufactured in a secure environment and certified in said secure environment as part of an approved network; performing asynchronous authentication, validation and encryption of data using said HSE, storing user permissions data and connection status data in an access control list used to define allowable data communications paths of said approved network, enabling communications of the communication modules with other computing system subjects to said access control list, performing asynchronous validation and encryption of data using security engine including identifying a user device (UD) that incorporates credentials embodied in hardware using a hardware-based module provisioned with one or more security aspects for securing the system, wherein security aspects comprising said hardware-based module communicating with a user of said user device and said HSE.

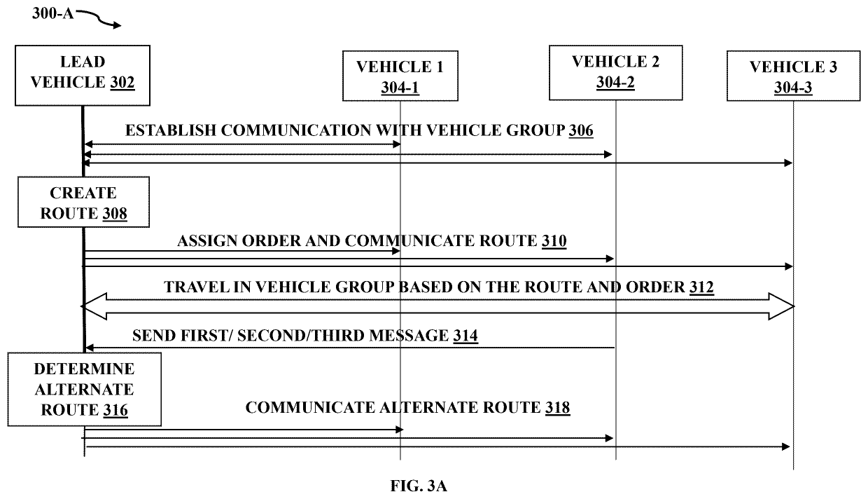

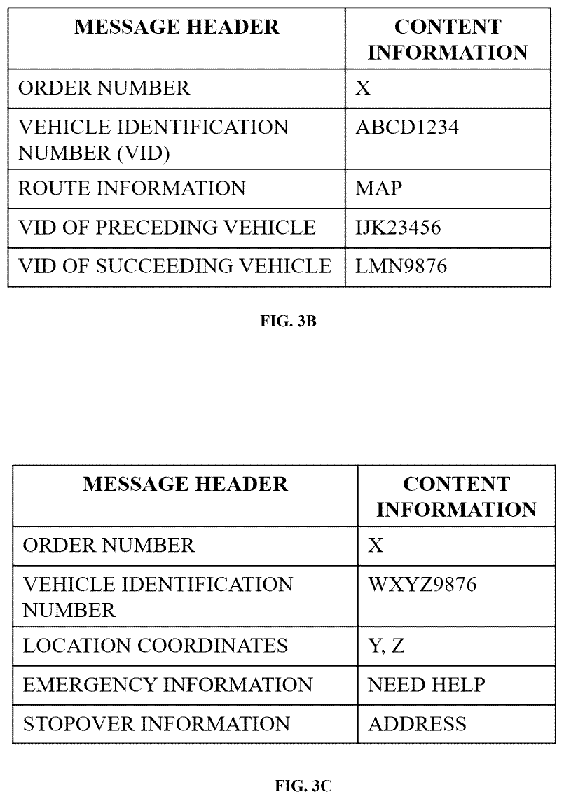

FIG. 3A illustrates message flow diagram 300-A between a lead vehicle and one or more vehicles in the vehicle group according to an embodiment.

Referring to FIG. 3A, exchange of messages between lead vehicle 302 and one or more vehicles 304-1, 304-2, 304-3 to maintain the daisy chain connection between the vehicles is shown. In some embodiments, the one or more vehicles desiring to join a vehicle group may transmit a request to join to the lead vehicle. The lead vehicle upon validating and accepting the request establishes communication between the requesting vehicle (not shown in the figure) and the one or more vehicles at step 306. In some embodiments, the lead vehicle may receive a location information associated with the one or more vehicles including the requesting vehicle, a source information (i.e., a common point from where all the vehicles in the vehicle group start), and a destination information (i.e., a common point to which all the vehicles in the vehicle group reach). Based on the source and destination information, lead vehicle 302 creates a route for the vehicle group at step 308. Further, the lead vehicle may also determine an order to be followed by the one or more vehicles. Lead vehicle 302 assigns the order for the one or more vehicles and communicates the route to be followed as a group at step 310. The lead vehicle and the one or more vehicles may travel as a group based on the route and the assigned order at step 312. Further, if any one of the one or more vehicles loses connection in the vehicle group (i.e., lost vehicle), the lost vehicle 304-2 may communicate at least one of the first/second/third messages to the lead vehicle at step 314. The first/second/third messages from 304-2 are based on scenarios discussed above with reference to FIGS. 1B-1D. Upon receiving the first/second/third message, lead vehicle 302 determines an alternate route for the lost vehicle at step 316. Lead vehicle 302 further communicates the alternate route to the lost vehicle and at least one of the preceding or the succeeding vehicle at step 318. In some embodiments, one or more vehicles 304-1, 304-2, 304-3 follow the alternate route to reach the destination or to re-establish connection with the vehicle group.

FIG. 3B illustrates a message format associated with a communication from the lead vehicle to one or more vehicles in the vehicle group according to an embodiment.

Referring to FIG. 3B, the message comprises at least one of an order number assigned to the vehicle to follow in the group. In some embodiments, the lead vehicle may assign the order based on the location information associated with the vehicle. Further, the message comprises an identification number associated with the lead vehicle, for example, a vehicle identification number, a route information (e.g., a map) to be followed by the one or more vehicles in the vehicle group, wherein the route information is customized for the vehicle group based on a travel plan.

Referring to FIG. 3B, the message further comprises a vehicle identification number (VID) associated with the preceding and the succeeding vehicle, i.e., VID of the preceding vehicle and VID of the succeeding vehicle.

FIG. 3C illustrates a message format associated with a communication from the one or more vehicles in the vehicle group to the lead vehicle according to an embodiment.

Referring to FIG. 3C, the message comprises at least one of an order number assigned to the vehicle to follow in the group, a vehicle identification number of the vehicle, location coordinates associated with the vehicle, emergency information, and stopover information associated with a resting place where the occupants of the vehicle desire to have a stopover. In some embodiments, the location coordinates comprise GPS coordinates associated with the vehicle based on the vehicle losing connection with the vehicle group. In some embodiments, the emergency information comprises an emergency notification based on the vehicle meeting with an accident. In some embodiments, the stopover information comprises an address of the desired stopover place.

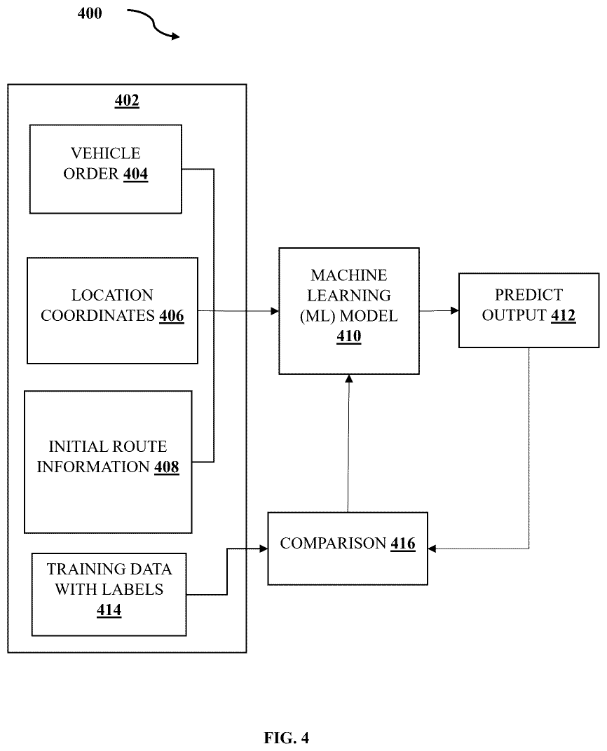

FIG. 4 illustrates an example block diagram 400 for an Artificial Intelligence and Machine Learning (AI/ML) model for maintaining a daisy chain connection.

Referring to FIG. 4, the machine learning model 410 may take as input 402 any data associated with vehicle order 404, location coordinates 406, initial route information 408 and learn to identify features within the data that are predictive of an alternate route for maintaining the daisy chain connection. Training data with labels 414 may comprise, for example, a historical data of alternate routes along a travel path, speed of vehicles in the vehicle group, current route of the vehicle group, location coordinates of the vehicles in the vehicle group, etc. In some embodiments, the training data, along with location coordinates of the vehicle that lost the connection with the group, may be transmitted to the cloud for determining the alternate route for maintaining the daisy chain connection or connection with the vehicle group. The systems and methods of the present disclosure may also provide data analytics information that may be used later to improve the prediction accuracy of generating the alternate routes to maintain the daisy chain connection.

In an embodiment, during training, machine learning model 410 may process the training data sample (e.g., vehicle order 404, location coordinates 406, and initial route information 408), and, based on the current parameters of machine learning model 410, predict output 412 which may be a generation of alternate route and selecting the vehicles for communicating the alternate route to maintain the daisy chain connection. In an embodiment, the real-time sensor data may be processed using one or more machine learning models 410, trained based on similar types of data to correctly generate the alternate route to maintain connection with the vehicle group. For example, comparison at step 416 may be based on a loss function that measures a difference between the predicted/detected output and training data with labels 414. Based on the comparison at step 416 or the corresponding output of the loss function, a training algorithm may update the parameters of machine learning model 410 with the objective of minimizing the differences or loss between subsequent predicted output 412 and corresponding labels 414. By iteratively training in this manner, machine learning model 410 may “learn” from the different training data samples and become better at predicting output 412. In an embodiment, machine learning model 410 is trained using data which is specific to a particular geographical area and different possible routes for predicting adjustments to the settings to provide accurate generation of the alternate route to maintain connection with the vehicle group. In an embodiment, the order information may be given weights and provided as an input to the AI/ML system.

Through training, machine learning model 410 may learn to identify predictive and non-predictive features and apply the appropriate weights to the features to optimize detecting and predictive accuracy of machine learning model 410. In embodiments where supervised learning is used and each training data sample has a label, the training algorithm may iteratively process each training data sample and generate a predicted output 412. Any suitable machine learning model and training algorithm may be used, including, e.g., neural networks, decision trees, clustering algorithms, and any other suitable machine learning techniques. Once trained, machine learning model 410 may take input data and generate the alternate route along with determining which vehicle (i.e., preceding or succeeding) the generated alternate route is to be sent to maintain the daisy chain connection. In an embodiment, machine learning model 410 is an artificial neural networks (ANN) model.

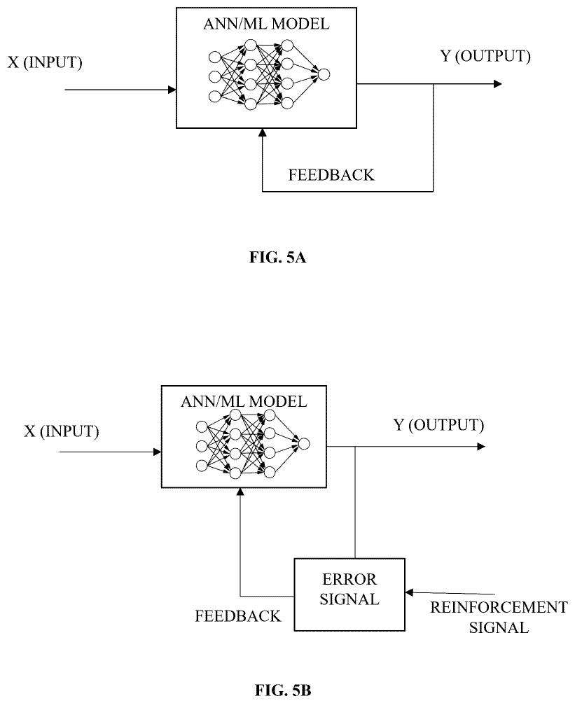

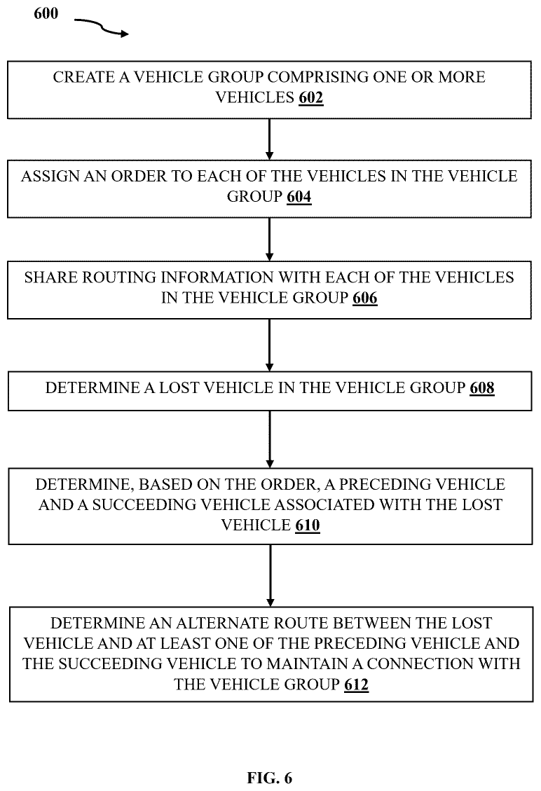

FIG. 5A shows a structure of the neural network/machine learning model with a feedback loop according to an embodiment. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. Input data comprises data associated with vehicle order 404, location coordinates 406, initial route information 408 and output data may comprise generating the alternate route to maintain the daisy chain connection or connection with the vehicle group. The model may learn from the data. Learning can be supervised learning and/or unsupervised learning and may be based on different scenarios and with different datasets. Supervised learning comprises logic using at least one of a decision tree, logistic regression, and support vector machines. Unsupervised learning comprises logic using at least one of a k-means clustering, a hierarchical clustering, a hidden Markov model, and an apriori algorithm. The output layer may be the generation of the alternate route and determination of vehicles (preceding/succeeding) for communicating the alternate route based on the inputs which may be data associated with vehicle order 404, location coordinates 406, initial route information 408.

In an embodiment, ANNs may be a Deep-Neural Network (DNN), which is a multilayer tandem neural network comprising Artificial Neural Networks (ANN), Convolution Neural Networks (CNN) and Recurrent Neural Networks (RNN) that can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback. The variations of weights in the hidden layer(s) will be adjusted to fit the expected outputs better while training the model. This will allow the model to provide results with far fewer mistakes. The neural network is featured with the feedback loop to adjust the system output dynamically as it learns from the new data. In machine backpropagation, propagation and feedback loops are used to train an Artificial Intelligence (AI) model and continuously improve it upon usage. As the incoming data that the model receives increases, there are more opportunities for the model to learn from the data. The feedback loops, or backpropagation algorithms, identify inconsistencies and feed the corrected information back into the model as an input. Even though the AI/ML model is trained well, with large sets of labeled data and concepts, after a while the models'performance may decline while adding new, unlabeled input due to many reasons which include, but not limited to, concept drift, recall precision degradation due to drifting away from true positives, and data drift over time. A feedback loop to the model keeps the AI results accurate and ensures that the model maintains its performance and improvement, even when new unlabeled data is assimilated. A feedback loop refers to the process by which an AI model's predicted output is reused to train new versions of the model.

Initially, when the AI/ML model is trained, a few labeled samples comprising both positive and negative examples of the concepts (e.g., different types of objects, different users interacting with different objects, tracking frequency, monitoring frequency etc.) are used that are meant for the model to learn how and what adjustments needs to be performed. Afterward, the model is tested using unlabeled data. By using, for example, deep learning and neural networks, the model can then make predictions on whether the desired output (for e.g., recognition of objects and the corresponding confidence score, dynamic tracking of the object and recording last known position, a prediction of objects that the user might likely be forgetting, and the locations within the vehicle where objects when placed may be likely forgotten etc.) is in the predicted accuracy level. However, in the cases where the model returns a low probability score, this input may be sent to a controller (maybe a human moderator) which verifies and, as necessary, corrects the result. The human moderator may be used only in exceptional cases. The feedback loop feeds labeled data, auto-labeled or controller-verified, back to the model dynamically and is used as training data so that the system can improve its predictions in real-time and dynamically. These models may be utilized at various levels, for example, (i) generation of alternate routes (ii) selection of vehicles (preceding/succeeding) for sending the alternate routes.

FIG. 5B shows a structure of the neural network/machine learning model with reinforcement learning according to an embodiment. The network receives feedback from authorized networked environments. Though the feedback logic is similar to supervised learning, the feedback obtained in this case is evaluative, not instructive, which means there is no teacher as in supervised learning. After receiving the feedback, the network performs adjustments of the weights to get better predictions in the future. Machine learning techniques, like deep learning, allow models to take labeled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

In an embodiment, the machine learning model is configured to learn using labeled data using a supervised learning method, wherein the supervised learning method comprises logic using at least one of a decision tree, a logistic regression, a support vector machine, a k-nearest neighbors, a Naïve Bayes, a random forest, a linear regression, a polynomial regression, and a support vector machine for regression.

In an embodiment, the machine learning model is configured to learn from the real-time data using an unsupervised learning method, wherein the unsupervised learning method comprises logic using at least one of a k-means clustering, a hierarchical clustering, a hidden Markov model, and an apriori algorithm.

In an embodiment, the machine learning model has a feedback loop, wherein the output from a previous step is fed back to the model in real-time to improve the performance and accuracy of the output of a next step.

In an embodiment, the machine learning model comprises a recurrent neural network model.

In an embodiment, the machine learning model has a feedback loop, wherein the learning is further reinforced with a reward for each true positive of the output of the system.

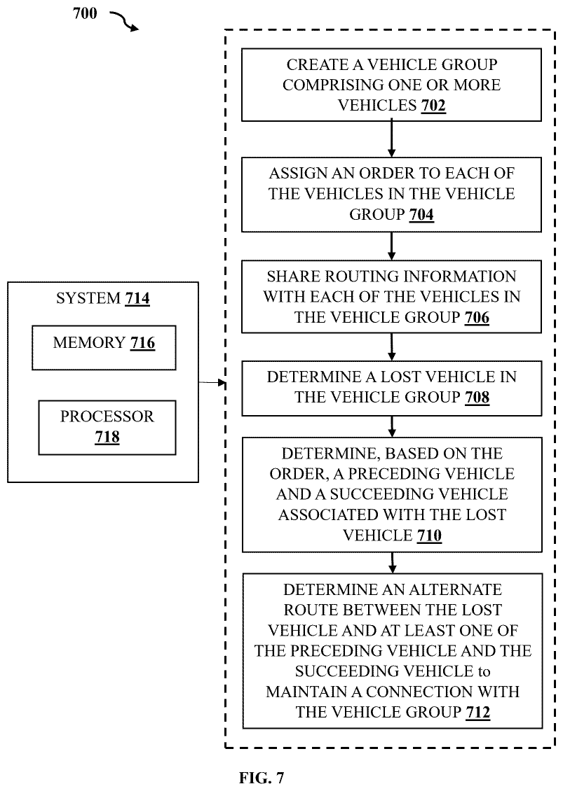

FIG. 6 illustrates a flow chart describing a method for maintaining a daisy chain connection according to an embodiment.

In some embodiments, method 600 may be carried out by a processor using instructions stored in a memory that, when executed, cause the processor to carry out method 600. In an embodiment, method 600 may be performed by system 200 as shown in FIG. 2A.

Referring to FIG. 6, method 600 may, at step 602, create a vehicle group comprising one or more vehicles. Method 600 may, at step 604, assign an order to each of the vehicles in the vehicle group. Method 600 may, at step 606, share routing information with the each of the vehicles in the vehicle group. Method 600 may, at step 608, determine a lost vehicle in the vehicle group. Method 600 may, at step 610 determine, based on the order, a preceding vehicle and a succeeding vehicle associated with the lost vehicle. Method 600 may, at step 612 determine an alternate route between the lost vehicle and at least one of the preceding vehicles and the succeeding vehicle to maintain a connection with the vehicle group.

In an embodiment, method 600, may further establish communication between the each of the vehicles in the vehicle group, wherein the each of the vehicles in the vehicle group communicate based on at least one of: an infotainment system, a voice command system, and a communication device associated with the vehicle.

In an embodiment, the vehicle group comprises a lead vehicle operable to monitor the vehicle group and control operations of the vehicle group.

In an embodiment, the routing information comprises a customized route created by the lead vehicle, wherein the customized route is based on a travel plan of the vehicle group. Further, the travel plan comprises a common source point and a common destination point.

In an embodiment, the each of the vehicles in the vehicle group travels from the common source point to the common destination point based on the customized route.

In some embodiments, the each of the vehicles in the vehicle group travels from the common source point to the common destination point based on the assigned order.

In some embodiments, a second vehicle follows a first vehicle in the vehicle group, wherein the first vehicle is a vehicle in the vehicle group assigned with order number one and the second vehicle is another vehicle in the vehicle group assigned with order number two.

In an embodiment, method 600, may further receive a first message from the lost vehicle, wherein the first message comprises location coordinates associated with a current location of the lost vehicle.

In an embodiment, method 600, may further estimate a distance between the lost vehicle and at least one of the preceding vehicles and the succeeding vehicle based on the first message; and generate the alternate route between the lost vehicle and at least one of the preceding vehicle and the succeeding vehicle based on the distance.

In an embodiment, method 600, may further communicate the alternate route to at least one of the lost vehicles, the preceding vehicle, and succeeding vehicle.

In an embodiment, method 600, may further determine whether a driver associated with the lost vehicle is following the alternate route; and communicate the alternate route to at least one of the preceding vehicles and the succeeding vehicle, based on the driver following the alternate route.

In an embodiment, the alternate route comprises a short-cut.

In an embodiment, the first message is associated with at least one of: the lost vehicle being held up at a traffic signal, taking a different turn, missing an exit, losing track of a lane, and being interfered by an external vehicle crossing the lane, wherein the external vehicle is a vehicle not part of the vehicle group.

In an embodiment, method 600, may further receive a second message from the lost vehicle, wherein the second message comprises a distress signal associated with the lost vehicle meeting with an emergency.

In an embodiment, method 600, may further determine, based on the second message, a location of the lost vehicle; and schedule an emergency help to the lost vehicle based on the location.

In an embodiment, method 600, may further receive a third message from the lost vehicle, wherein the third message comprises a stopover plan; and determine modifications to the routing information based on the third message; and share the modified routing information to the each of the vehicles in the vehicle group.

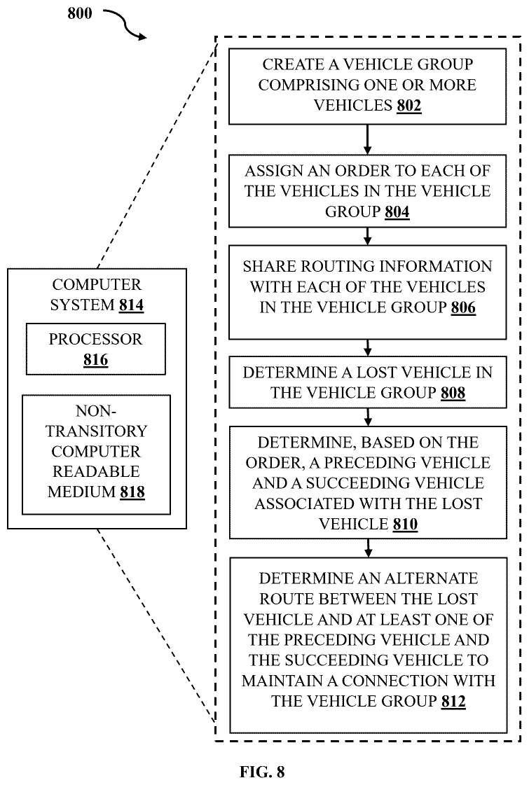

FIG. 7 illustrates block diagram 700 of the system implementing the method for maintaining a daisy chain connection according to an embodiment.

According to an embodiment, disclosed is system 714 comprising processor 718 and memory 716, wherein memory 716 storing processor-executable instructions, which on execution, causes the processor to: create a vehicle group comprising one or more vehicles at step 702, assign an order to each of the vehicles in the vehicle group at step 704, share routing information with the each of the vehicles in the vehicle group at step 706, determine a lost vehicle in the vehicle group at step 708, determine, based on the order, a preceding vehicle and a succeeding vehicle associated with the lost vehicle at step 710, and determine an alternate route between the lost vehicle and at least one of the preceding vehicle and the succeeding vehicle to maintain a connection with the vehicle group at step 712.

In some embodiments, the processor-executable instructions, which on execution, further cause processor 718 to establish communication between the each of the vehicles in the vehicle group.

In some embodiments, the processor-executable instructions, which on execution, further cause processor 718 to receive a first message from the lost vehicle, wherein the first message comprises location coordinates associated with a current location of the lost vehicle.

In some embodiments, the processor-executable instructions, which on execution, further cause processor 718 to estimate a distance between the lost vehicle and at least one of the preceding vehicle and the succeeding vehicle based on the first message; and generate the alternate route between the lost vehicle and at least one of the preceding vehicle and the succeeding vehicle based on the distance.

In some embodiments, the processor-executable instructions, which on execution, further cause processor 718 to communicate the alternate route to at least one of the lost vehicle, the preceding vehicle, and succeeding vehicle.

In some embodiments, the processor-executable instructions, which on execution, further cause processor 718 to determine whether a driver associated with the lost vehicle is following the alternate route; and communicate the alternate route to at least one of the preceding vehicle and the succeeding vehicle, based on the driver following the alternate route.

In some embodiments, the processor-executable instructions, which on execution, further cause processor 718 to receive a second message from the lost vehicle, wherein the second message comprises a distress signal associated with the lost vehicle meeting with an emergency.

In some embodiments, the processor-executable instructions, which on execution, further cause processor 718 to determine, based on the second message, a location of the lost vehicle; and schedule an emergency help to the lost vehicle based on the location.

In some embodiments, the processor-executable instructions, which on execution, further cause processor 718 to receive a third message from the lost vehicle, wherein the third message comprises a stopover plan; and determine modifications to the routing information based on the third message; and share the modified routing information to the each of the vehicles in the vehicle group

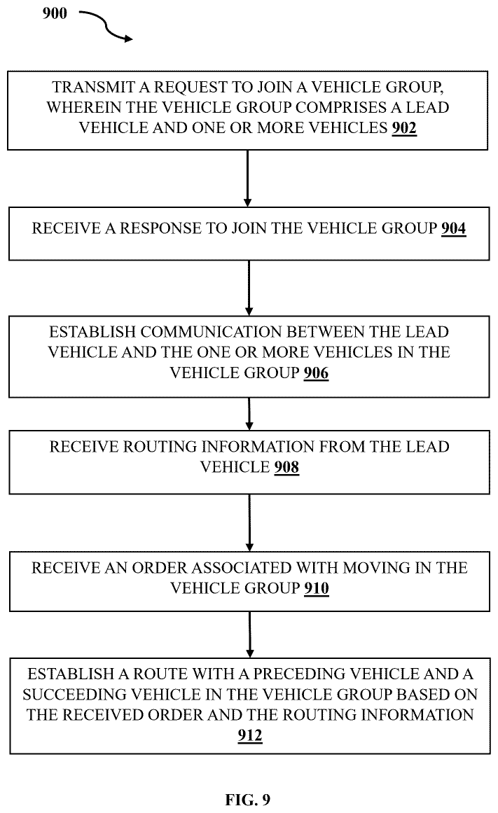

FIG. 8 illustrates block diagram 800 of the method executed by the non-transitory computer-readable medium for maintaining a daisy chain connection according to an embodiment.

According to an embodiment, disclosed is computer system 814 comprising non-transitory computer-readable medium 818 having stored thereon instructions executable by processor 816 to perform operations comprising: creating a vehicle group comprising one or more vehicles at step 802; assigning an order to each of the vehicles in the vehicle group at step 804; sharing a routing information with the each of the vehicles in the vehicle group at step 806; determining a lost vehicle in the vehicle group at step 808; determining, based on the order, a preceding vehicle and a succeeding vehicle associated with the lost vehicle at step 810; and determining an alternate route between the lost vehicle and at least one of the preceding vehicle and the succeeding vehicle to maintain a connection with the vehicle group at step 812.

In some embodiments, non-transitory computer-readable medium 818 further comprises instructions to perform operations comprising: establishing communication between the each of the vehicles in the vehicle group.

In some embodiments, non-transitory computer-readable medium 818 further comprises instructions to perform operations comprising: receiving a first message from the lost vehicle, wherein the first message comprises location coordinates associated with a current location of the lost vehicle.

In some embodiments, non-transitory computer-readable medium 818 further comprises instructions to perform operations comprising: estimating a distance between the lost vehicle and at least one of the preceding vehicle and the succeeding vehicle based on the first message; and generating the alternate route between the lost vehicle and at least one of the preceding vehicle and the succeeding vehicle based on the distance.

In some embodiments, non-transitory computer-readable medium 818 further comprises instructions to perform operations comprising: communicating the alternate route to at least one of the lead vehicle, the preceding vehicle, and succeeding vehicle.

In some embodiments, non-transitory computer-readable medium 818 further comprises instructions to perform operations comprising: determining whether a driver associated with the lost vehicle is following the alternate route; and communicating the alternate route to at least one of the lead vehicle, the preceding vehicle, and succeeding vehicle, based on the driver following the alternate route.

In some embodiments, non-transitory computer-readable medium 818 further comprises instructions to perform operations comprising: receiving a second message from the lost vehicle, wherein the second message comprises a distress signal associated with the lost vehicle meeting with an emergency.

In some embodiments, non-transitory computer-readable medium 818 further comprises instructions to perform operations comprising: determining, based on the second message, a location of the lost vehicle; and scheduling an emergency help to the lost vehicle based on the location.

In some embodiments, non-transitory computer-readable medium 818 further comprises instructions to perform operations comprising: receiving a third message from the lost vehicle, wherein the third message comprises a stopover plan; and determining modifications to the routing information based on the third message; and sharing the modified routing information to the each of the vehicles in the vehicle group.

FIG. 9 illustrates a flow chart describing a method to connect with a preceding and a succeeding vehicle in the vehicle group according to an embodiment.

In some embodiments, method 900 may be associated with a follower vehicle desiring to be a part of the vehicle group.

Referring to FIG. 9, method 900, may at step 902, transmit a request to join a vehicle group, wherein the vehicle group comprises a lead vehicle and one or more vehicles. Method 900, may at step 904, receive a response to join the vehicle group. Method 900, may at step 906, establish communication between the lead vehicle and the one or more vehicles in the vehicle group. Method 900, may at step 908, receive routing information from the lead vehicle. Method 900, may at step 910, receive an order associated with moving in the vehicle group. Method 900, may at step 912, establish a route with a preceding vehicle and a succeeding vehicle in the vehicle group based on the received order and the routing information.

In an embodiment, method 900 may further enable navigation from a common source point to a common destination point based on the established route.

In an embodiment, method 900 may further determine a loss of established route; and generate an alternate route with at least one of the preceding vehicle and the succeeding vehicle.

In an embodiment, method 900 may further communicate the alternate route to at least one of the lead vehicle, the preceding vehicle, and the succeeding vehicle; and rejoin the vehicle group based on the alternate route

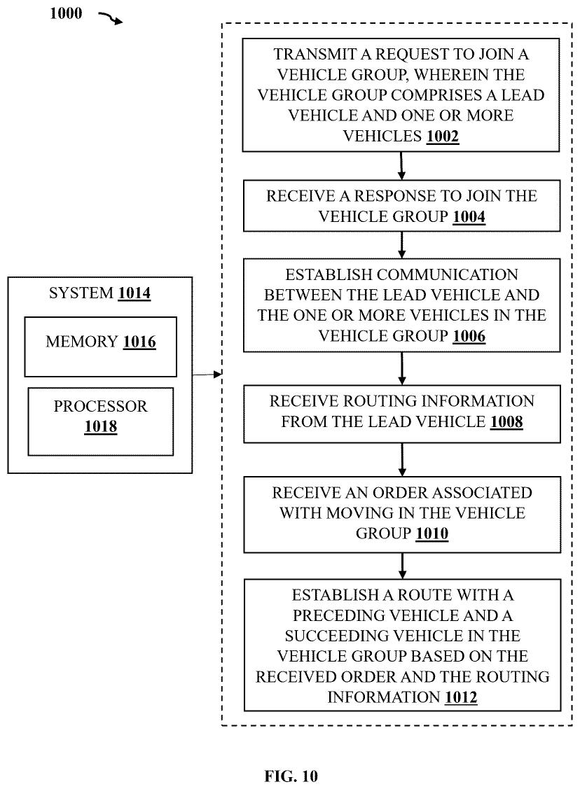

FIG. 10 illustrates block diagram 1000 of the system implementing the method to connect with a preceding and a succeeding vehicle in the vehicle group according to an embodiment.

According to an embodiment, disclosed is system 1014 comprising processor 1018; and memory 1016, wherein memory 1016 storing processor-executable instructions, which on execution, causes the processor to: transmit a request to join a vehicle group, wherein the vehicle group comprises a lead vehicle and one or more vehicles at step 1002; receive a response to join the vehicle group at step 1004; establish communication between the lead vehicle and the one or more vehicles in the vehicle group at step 1006; receive routing information from the lead vehicle at step 1008; receive an order associated with moving in the vehicle group at step 1010; and establish a route with a preceding vehicle and a succeeding vehicle in the vehicle group based on the received order and the routing information at step 1012.

In some embodiments, the processor-executable instructions, which on execution, further cause processor 1018 to enable a navigation from a common source point to a common destination point based on the established route.

In some embodiments, the processor-executable instructions, which on execution, further cause processor 1018 to determine a loss of established route; and generate an alternate route with at least one of the preceding vehicle and the succeeding vehicle.

In some embodiments, the processor-executable instructions, which on execution, further cause processor 1018 to communicate the alternate route to at least one of the lead vehicle, the preceding vehicle, and the succeeding vehicle; and rejoin the vehicle group based on the alternate route.

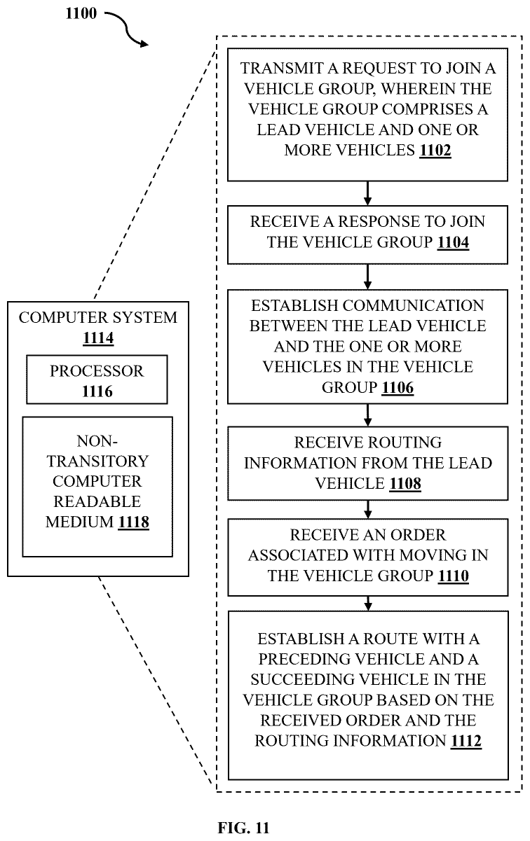

FIG. 11 illustrates block diagram 1100 of the method executed by the non-transitory computer-readable medium for connecting with a preceding and a succeeding vehicle in the vehicle group according to an embodiment.

According to an embodiment, disclosed is computer system 1114 with non-transitory computer-readable medium 1118 having stored thereon instructions executable by processor 1116 to perform operations comprising: transmitting a request to join a vehicle group, wherein the vehicle group comprises a lead vehicle and one or more vehicles at step 1102; receiving a response to join the vehicle group at step 1104; establishing communication between the lead vehicle and the one or more vehicles in the vehicle group at step 1106; receiving a routing information from the lead vehicle at step 1108; receiving an order associated with moving in the vehicle group at step 1110; and establishing a route with a preceding vehicle and a succeeding vehicle in the vehicle group based on the routing information and the received order 1112.

In some embodiments, non-transitory computer-readable medium 1118 further comprises instructions to perform operations comprising: enabling a travel from a common source point to a common destination point based on the established route.

In some embodiments, non-transitory computer-readable medium 1118 further comprises instructions to perform operations comprising: determining a loss of established route; and generating an alternate route with at least one of the preceding vehicle and the succeeding vehicle.

In some embodiments, non-transitory computer-readable medium 1118 further comprises instructions to perform operations comprising: communicating the alternate route to at least one of the lead vehicle, the preceding vehicle, and the succeeding vehicle; and rejoining the travel based on the alternate route.

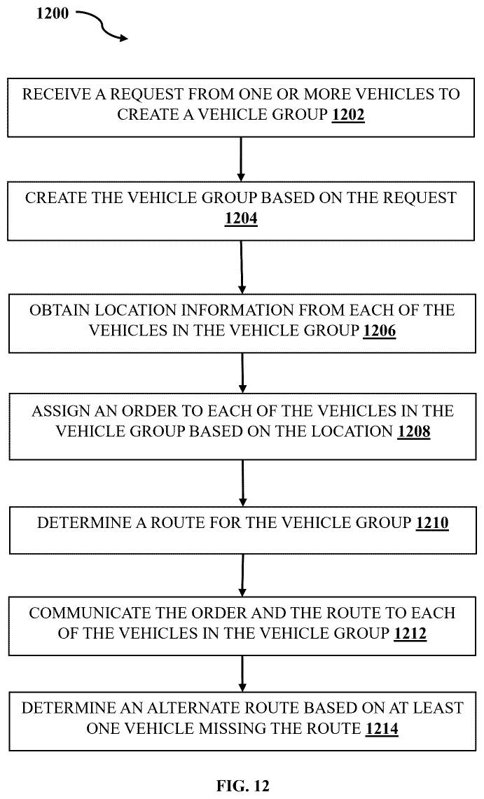

FIG. 12 illustrates a flow chart describing a method of monitoring and controlling the operations of the vehicle group according to an embodiment.

Referring to FIG. 12, method 1200 may, at step 1202, receive a request from one or more vehicles to create a vehicle group. Method 1200 may, at step 1204, create the vehicle group based on the request. Method 1200 may, at step 1206, obtain location information from each of the vehicles in the vehicle group. Method 1200 may, at step 1208, assign an order to the each of the vehicles in the vehicle group based on the location information. Method 1200 may, at step 1210, determine a route for the vehicle group. Method 1200 may, at step 1212, communicate the order and the route to the each of the vehicles in the vehicle group. Method 1200 may, at step 1214, determine an alternate route based on at least one vehicle missing the route.

In an embodiment, method 1200 may further receive at least one of a first message, a second message, and a third message from the at least one vehicle missing the route; determine the alternate route based on the received at least one of the first message, the second message, and the third message for the at least one vehicle to maintain connection with the vehicle group; and communicate the alternate route to the at least one vehicle and at least one of a vehicle preceding and succeeding the at least one vehicle.

In an embodiment, each of the vehicles in the vehicle group travels from a common source point to a common destination point based on the route and following the order.

In an embodiment, method 1200 may further communicate the order and the route to a first vehicle; and command the first vehicle to further communicate the order and the route to a second vehicle, wherein the second vehicle follows the first vehicle from the common source point to the common destination point.

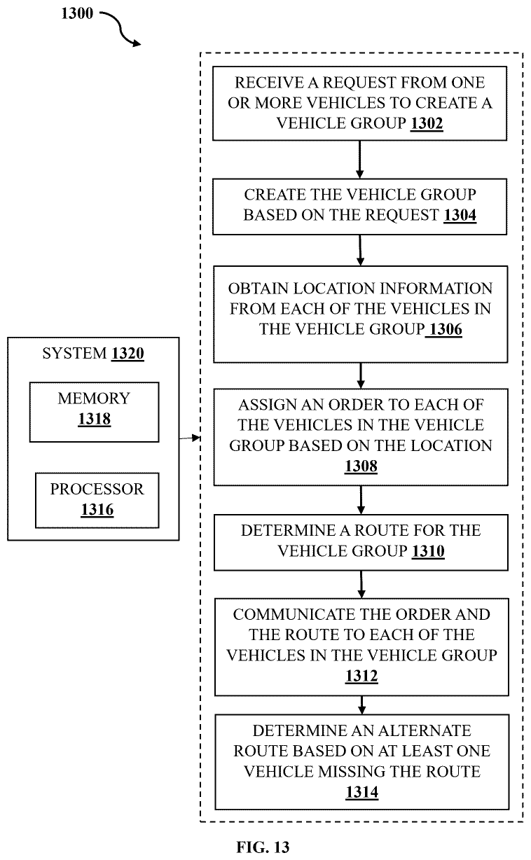

FIG. 13 illustrates block diagram 1300 of the system implementing the method of monitoring and controlling the operations of the vehicle group according to an embodiment.

According to an embodiment, disclosed is system 1320 comprising processor 1316; and memory 1318, wherein memory 1318 storing processor-executable instructions, which on execution, cause the processor to: receive a request from one or more vehicles to create a vehicle group at step 1302; create the vehicle group based on the request at step 1304; obtain location information from each of the vehicles in the vehicle group at step 1306; assign an order to the each of the vehicles in the vehicle group based on the location information at step 1308; determine a route for the vehicle group at step 1310; communicate the order and the route to the each of the vehicles in the vehicle group at step 1312; and determine an alternate route based on at least one vehicle missing the route at step 1314.

In some embodiments, the processor-executable instructions, which on execution, further cause processor 1316 to receive at least one of a first message, a second message, and a third message from the at least one vehicle missing the route; determine the alternate route based on the received at least one of the first message, the second message, and the third message for the at least one vehicle to maintain connection with the vehicle group; and communicate the alternate route to the at least one vehicle and at least one of a vehicle preceding and succeeding the at least one vehicle.

In some embodiments, the processor-executable instructions, which on execution, further cause processor 1316 to communicate the order and the route to a first vehicle; and command the first vehicle to further communicate the order and the route to a second vehicle, wherein the second vehicle follows the first vehicle from the common source point to the common destination point.

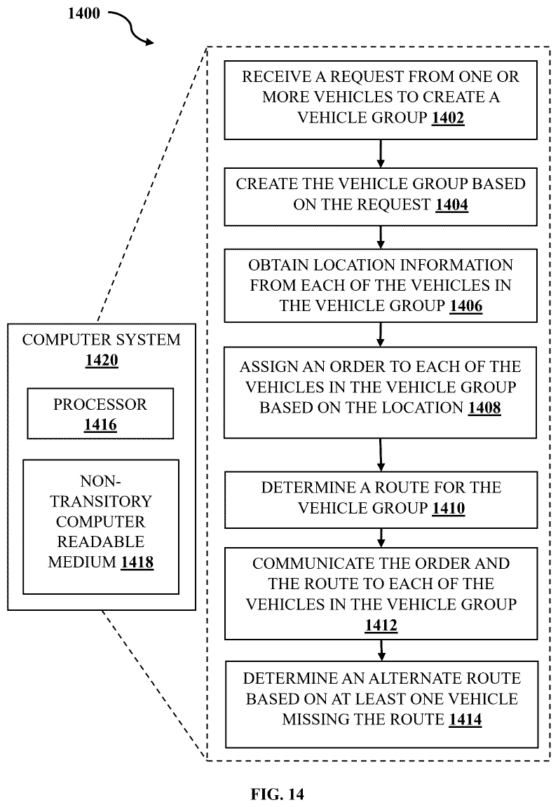

FIG. 14 illustrates block diagram 1400 of the method executed by the non-transitory computer-readable medium for monitoring and controlling the operations of the vehicle group according to an embodiment.

According to an embodiment, disclosed is computer system 1420 comprising non-transitory computer-readable medium 1418 having stored thereon instructions executable by processor 1416 to perform operations comprising: receiving a request from one or more vehicles to create a vehicle group at step 1402; creating the vehicle group based on the request at step 1404; obtaining location information from each of the vehicles in the vehicle group at step 1406; assigning an order to the each of the vehicles in the vehicle group based on the location information at step 1408; determining a route for the vehicle group at step 1410; communicating the order and the route to the each of the vehicles in the vehicle group at step 1412; and determining an alternate route based on at least one vehicle missing the route at step 1414.

In some embodiments, non-transitory computer-readable medium 1418 further comprises instructions to perform operations comprising: receiving at least one of a first message, a second message, and a third message from the at least one vehicle missing the route; determining the alternate route based on receiving the at least one of the first message, the second message, and the third message for the at least one vehicle to maintain connection with the vehicle group; and communicating the alternate route to the at least one vehicle and at least one of a vehicle preceding and succeeding the at least one vehicle.

In some embodiments, non-transitory computer-readable medium 1418 further comprises instructions to perform operations comprising: communicating the order and the route to a first vehicle; and commanding the first vehicle to further communicate the order and the route to a second vehicle, wherein the second vehicle follows the first vehicle from the common source point to the common destination point.

FIG. 15A shows block diagram 1500-A of a cyber security module in view of the system and server according to an embodiment.

Referring to FIG. 15A, system 1500 comprising processor 1502, communication module 1504, cyber security module 1506, and information security management module 1508 in communication with server 1510, is shown. The communication of data between system 1500 and server 1510 through communication module 1504 is first verified by information security management module 1508 before being transmitted from system 1500 to server 1510 or from server 1510 to system 1500. Information security management module 1508 is operable to analyze the data for potential cyber security threats, to encrypt the data when no cyber security threat is detected, and to transmit the data encrypted to system 1500 or server 1510.

FIG. 15B shows an embodiment of the cyber security module, in accordance with some embodiments of the present disclosure.

Referring to FIG. 15B, method 1500-B for securing the data through cyber security module 1506 is shown. At step 1512, the information security management module 1508 is operable to receive data from the communication module. At step 1514, the information security management module exchanges a security key at a start of the communication between the communication module and the server. At step 1516, the information security management module receives a security key from the server. At step 1518, the information security management module authenticates an identity of the server by verifying the security key. At step 1520, the information security management module analyzes the security key for potential cyber security threats. At step 1522, the information security management module negotiates an encryption key between the communication module and the server. At step 1524, the information security management module receives the encrypted data. At step 1526, the information security management module transmits the encrypted data to the server when no cyber security threat is detected.

FIG. 15C shows another embodiment of the cyber security module, in accordance with some embodiments of the present disclosure.

Referring to FIG. 15C, method 1500-C for securing the data through the cyber security module 1506 is shown. At step 1528, the information security management module is operable to: exchange a security key at a start of the communication between the communication module and the server. At step 1530, the information security management module receives a security key from the server. At step 1532, the information security management module authenticates an identity of the server by verifying the security key. At step 1534, the information security management module analyzes the security key for potential cyber security threats. At step 1536, the information security management module negotiates an encryption key between the communication module and the server. At step 1538, the information security management module receives encrypted data. At step 1540, information security management module 1508 decrypts the encrypted data, and performs an integrity check of the decrypted data. At step 1542, information security management module 1508 transmits the decrypted data to the communication module when no cyber security threat is detected.

In an embodiment, the integrity check is a hash-signature verification using a Secure Hash Algorithm 256 (SHA256) or a similar method. In an embodiment, the information security management module is configured to perform asynchronous authentication and validation of the communication between the communication module and the server. In an embodiment, the information security management module is configured to raise an alarm if a cyber security threat is detected. In an embodiment, the information security management module is configured to discard the encrypted data received if the integrity check of the encrypted data fails. In an embodiment, the information security management module is configured to check the integrity of the decrypted data by checking accuracy, consistency, and any possible data loss during the communication through the communication module.

In an embodiment, the server is physically isolated from the system through the information security management module. When the system communicates with the server as shown in FIG. 15A, identity authentication is first carried out on the system and then on the server. The system is responsible for communicating/exchanging a public key of the system and a signature of the public key with the server. The public key of the system and the signature of the public key are sent to the information security management module. The information security management module decrypts the signature and verifies whether the decrypted public key is consistent with the received original public key or not. If the decrypted public key is verified, the identity authentication is passed. Similarly, the system and the server carry out identity authentication on the information security management module. After the identity authentication is passed on to the information security management module, the two communication parties, the system, and the server, negotiate an encryption key and an integrity check key for data communication of the two communication parties through the authenticated asymmetric key. A session ID number is transmitted in the identity authentication process, so that the key needs to be bound with the session ID number; when the system sends data to the outside, the information security gateway receives the data through the communication module, performs integrity authentication on the data, then encrypts the data through a negotiated secret key, and finally transmits the data to the server through the communication module. When the information security management module receives data through the communication module, the data is decrypted first, integrity verification is carried out on the data after decryption, and if verification is passed, the data is sent out through the communication module; otherwise, the data is discarded.

In an embodiment, the identity authentication is realized by adopting an asymmetric key with a signature. In an embodiment, the signature is realized by a pair of asymmetric keys which are trusted by the information security management module and the system, wherein the private key is used for signing the identities of the two communication parties, and the public key is used for verifying that the identities of the two communication parties are signed. Signing identity comprises a public and a private key pair. In other words, signing identity is referred to as the common name of the certificates which are installed in the user's machine. In an embodiment, both communication parties need to authenticate their own identities through a pair of asymmetric keys, and a task in charge of communication with the information security management module of the system is identified by a unique pair of asymmetric keys. In an embodiment, the dynamic negotiation key is encrypted by adopting an Rivest-Shamir-Adleman (RSA) encryption algorithm. RSA is a public-key cryptosystem that is widely used for secure data transmission. The negotiated keys include a data encryption key and a data integrity check key. In an embodiment, the data encryption method is a Triple Data Encryption Algorithm (3DES) encryption algorithm. The integrity check algorithm is a Hash-based Message Authentication Code (HMAC-MD5-128) algorithm. When data is output, the integrity check calculation is carried out on the data, the calculated Message Authentication Code (MAC) value is added with the header of the value data message, then the data (including the MAC of the header) is encrypted by using a 3DES algorithm, the header information of a security layer is added after the data is encrypted, and then the data is sent to the next layer for processing. In an embodiment the next layer refers to a transport layer in the Transmission Control Protocol/Internet Protocol (TCP/IP) model.

The information security management module ensures the safety, reliability, and confidentiality of the communication between the system and the server through the identity authentication when the communication between the two communication parties starts the data encryption and the data integrity authentication. The method is particularly suitable for an embedded platform which has less resources and is not connected with a Public Key Infrastructure (PKI) system and can ensure that the safety of the data on the server cannot be compromised by a hacker attack under the condition of the Internet by ensuring the safety and reliability of the communication between the system and the server.

In some embodiments, the communication between lead vehicle 302 and one or more vehicles 304-1, 304-2, 304-3 as shown in FIG. 3A may be secured by the cyber security module. Vehicles 304-1, 304-2, 304-3 may include the communication module coupled to the information security management module. A request for connecting (i.e., connection request, request to join) with the vehicle group may be sent to the lead vehicle through the communication module. In some embodiments, the first message, second message, and the third message may be sent to the lead vehicle through the communication module. The connection request and the first, second, and third messages may be verified by the information security management module before being transmitted from the one or more vehicles to the lead vehicle. The information security management module is operable to analyze the data for potential cyber security threats, to encrypt the data when no cyber security threat is detected, and to transmit the data encrypted to the one or more vehicles or the lead vehicle.

In an embodiment, the lead vehicle may securely transmit a response message to establish communication with the one or more vehicles. In some embodiments, the lead vehicle may securely transmit routing information, and an order assigned for traveling in the vehicle group to the one or more vehicles. The vehicle, upon receiving the routing information and the order, may travel from a common source to a common destination following the routing information and the assigned order.

In some embodiments, the lead vehicle may transmit securely the alternate route to the one or more vehicles based on the received first/second/third message from the one or more vehicles.

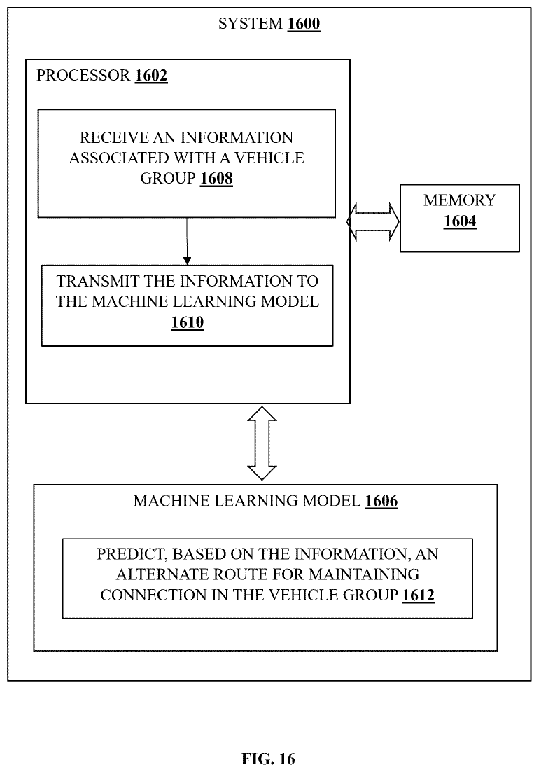

FIG. 16 illustrates a block diagram of a system for maintaining a daisy chain connection according to an embodiment.

Referring to FIG. 16, system 1600 comprising processor 1602, memory 1604, and machine learning model 1606 is shown. Memory 1604 is operatively coupled to the processor, wherein the memory comprises processor-executable instructions, which on execution, cause the processor to: receive an information associated with a vehicle group at step 1608; and transmit the information to the machine learning model at step 1610, wherein the machine learning model is operable to: predict, based on the information, an alternate route for maintaining connection in the vehicle group at step 1612.

In an embodiment, the information comprises at least one of: details related to a number of vehicles in the vehicle group, an order assigned to the each of the vehicles in the vehicle group, routing information of the vehicle group, a lost vehicle, and location information associated with the lost vehicle.

In an embodiment of system 1600, the machine learning model is configured to learn using labeled data using a supervised learning method, wherein the supervised learning method comprises logic using at least one of a decision tree, a logistic regression, a support vector machine, a k-nearest neighbors, a Naïve Bayes, a random forest, a linear regression, a polynomial regression, and a support vector machine for regression.

In an embodiment of system 1600, the machine learning model is configured to learn from a real-time data using an unsupervised learning method, wherein the unsupervised learning method comprises logic using at least one of a k-means clustering, a hierarchical clustering, a hidden Markov model, and an apriori algorithm.

In an embodiment of system 1600, the machine learning model has a feedback loop, wherein an output from a previous step is fed back to the machine learning model in real-time to improve the performance and accuracy of the output of a next step.

In an embodiment of system 1600, the machine learning model has a feedback loop, wherein the learning is further reinforced with a reward for each true positive of an output of the system.

In an embodiment of system 1600, the machine learning model comprises a recurrent neural network model.

In an aspect, the present disclosure discloses forming a daisy chain connection between vehicles to form a vehicle fleet.

Business Problem: Organizing a vehicle fleet is a bit difficult without proper connection between vehicles. Communication may be established between appropriate vehicles at high cost. In order to reduce costs and to establish effective vehicle communication, there is a need for an efficient connection between vehicles.

Technical Problem: Currently, during the vehicle fleet, each driver associated with a following vehicle maintains eye contact with a preceding vehicle in the fleet to follow the route. However, when other vehicles, not part of the group, join the chain because of traffic, the driver may lose eye contact or line of sight with its preceding vehicle and may lose focus, on safe driving, to find the group. This could lead to safety issues. Further, the connections between the vehicles should always be active to manage and maintain the vehicle fleet. The vehicle and its preceding and succeeding vehicles should always be connected to maintain the vehicle fleet. Accordingly, there remains a need for a simple and effective connection between the vehicles to collaborate in a vehicle fleet.

Business Solution: Establishing a daisy chain connection and exchanging information associated with the route and order between each of the vehicles in a vehicle group enables maintaining a connection with the vehicle group under all circumstances.

Technical Solution: In one aspect, the present disclosure discusses a system and method for forming a daisy chain connection. The system may create a vehicle group comprising one or more vehicles and determine a lead vehicle. The lead vehicle may monitor and control the operations of the one or more vehicles. The follower vehicles follow the instructions from the lead vehicle and/or the preceding vehicles and maintain the vehicle fleet.

Technical Result: Forming a daisy connection and establishing connection between the vehicles to organize and to manage the vehicle fleet.

How Technical Solution is a Technological Advancement: The technical solution enables forming a vehicle fleet in an organized manner upon receiving the request from the vehicle fleet. Upon confirmation, the system automatically sends notifications as well as instructions to the vehicles to join the vehicle fleet. The system also categorizes the vehicle and assigns the order to each vehicle based on the vehicle information. Further, the system provides the instructions in real-time based on real-time travel path information to maintain the vehicle fleet.

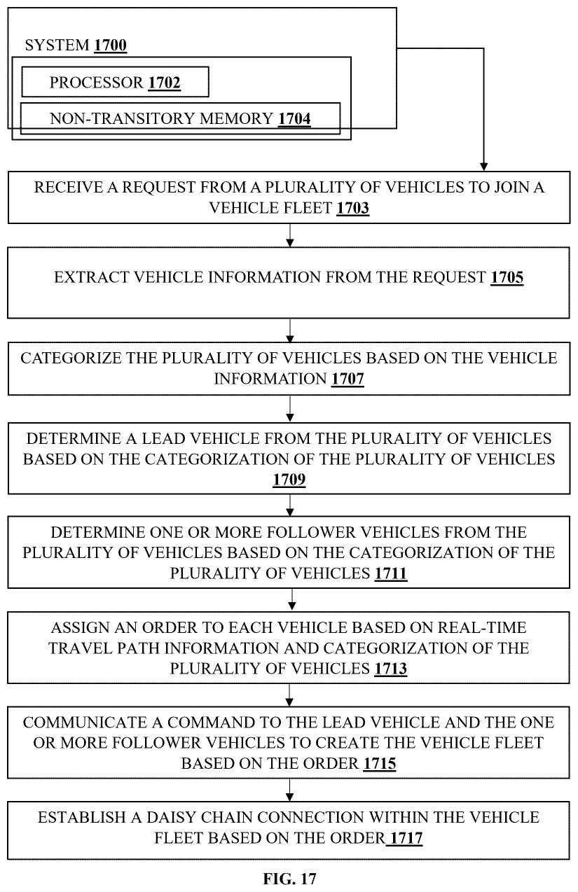

Technical Details Specific to the Technical Solution: In an aspect, a system is described. As an example, FIG. 17 illustrates a system, according to one or more embodiments. System 1700 comprises: processor 1702 storing instructions in non-transitory memory 1704 that, when executed, cause processor 1702 to: receive a request from a plurality of vehicles to join a vehicle fleet (at step 1703); extract vehicle information from the request (at step 1705), wherein the vehicle information comprises at least one of a vehicle model, a vehicle make, a vehicle type, history of vehicle fleet, a vehicle identification number (ID), a vehicle color, a vehicle specification, and a vehicle service and maintenance history; categorize the plurality of vehicles based on the vehicle information (at step 1707); determine a lead vehicle from the plurality of vehicles based on the categorization of the plurality of vehicles (at step 1709); determine one or more follower vehicles from the plurality of vehicles based on the categorization of the plurality of vehicles (at step 1711); assign an order to each vehicle based on real-time travel path information and the categorization of the plurality of vehicles (at step 1713); communicate a command to the lead vehicle and the one or more follower vehicles to create the vehicle fleet based on the order (at step 1715); and establish a daisy chain connection within the vehicle fleet based on the order (at step 1717).

The request may be in a predefined format. In one embodiment, the request is in a predefined message format. The message format may comprise headers and contents respective to those headers. In one embodiment, the request is in an interactive Portable Document Format (PDF). In one embodiment, the request comprises the vehicle information as a watermark in the interactive PDF. The request comprises the vehicle information.

In one embodiment, the processor 1702 comprises an artificial intelligence engine. The artificial intelligence engine analyzes the request and identifies one or more keywords related to the vehicle information. The artificial intelligence engine analyzes the headers and their respective contents and identifies one or more keywords. The artificial intelligence engine then determines one or more contents that comprises the vehicle information based on one or more keywords. In one embodiment, the processor 1702 through the artificial intelligence engine extracts the vehicle information from the request. As an example, the processor 1702, through the artificial intelligence engine analyzes the headers and their respective contents and determines one or more keywords such as vehicle identification number (ID) and vehicle model from the request. The processor through the artificial intelligence engine then determines the associated contents from the request.

The processor 1702 categorizes the plurality of vehicles based on the vehicle information as at least one of a first grade, a second grade, and a third grade. In one embodiment, the processor determines the first vehicle as the lead vehicle when the first vehicle is in the first grade. In one embodiment, the processor determines one or more second vehicles as the one or more follower vehicles when the one or more second vehicles are in the second grade.

As an example, the processor 1702 may categorize the vehicle with the oldest model as the first grade and the vehicle with the newest model as the second grade and so on. In one embodiment, the processor 1702 determines one or more keywords such as vehicle color and vehicle model from the request. As another example, the processor 1702 may categorize the vehicle with military green color and oldest model as the first grade and the rest of the vehicles as a second grade.

The processor 1702 may sort the plurality of vehicles based on the vehicle information to assign the order. In one embodiment, the processor 1702 determines the lead vehicle and the one or more follower vehicles based on the sorting. As an example, the processor 1702 may categorize the vehicle with the oldest model as the lead vehicle and subsequent vehicles with the newest model as follower vehicles as. As another example, the processor 1702 may categorize the vehicle with military green color as the lead vehicle and other color vehicles as follower vehicles. As another example, processor 1702 may also determine the vehicle having highest safety features as the lead vehicle and the rest as follower vehicles. In an embodiment, the processor 1702 may determine the vehicle with highest safety features based on the vehicle specification.

The processor 1702 is operable to receive real-time travel path information from an external system. The real-time travel path information comprises at least one of a traffic condition, a road surface condition, a road infrastructure, an environmental weather condition, road signs, and routing information. In one embodiment, the real-time travel path information is in at least one of a pictorial representation, and a textual representation.

In one embodiment, the processor 1702 is operable to map the road infrastructure with virtual place holders based on the real-time travel path information and the categorization of the plurality of vehicles. The processor 1702 generates a virtual place holder for each vehicle. The processor 1702 virtually simulates the road infrastructure with lanes, properties, road signs, bridges, bumps, etc. based on the real-time travel path information. The processor 1702 determines the dimensions of the lanes and the number of the lanes in the road based on the real-time travel path information. The processor 1702 depicts a pictorial representation of the road infrastructure.

In one embodiment, the processor 1702 is operable to assign the order to each vehicle of the plurality of vehicles in accordance with the virtual place holders based on the real-time travel path information and the categorization of the plurality of vehicles. The processor 1702 then accumulates the road infrastructure with the virtual place holders based on the categorization of the plurality of vehicles.

In one embodiment, the processor 1702 is operable to assign the order to each vehicle of the plurality of vehicles in accordance with the virtual place holders and to comply with safety based on the real-time travel path information and the categorization of the plurality of vehicles. The pictorial representation of the accumulation of the road infrastructure with the virtual place holders based on the categorization of the plurality of vehicles depicts the position for each vehicle on the vehicle fleet. The pictorial representation of the accumulation of the road infrastructure with the virtual place holders further depicts the connection to be established between the vehicles. In one embodiment, the processor 1702 renders the path flow of connection to be established between the succeeding vehicles. The connection may be a daisy chain connection. The processor 1702 then communicates a pictorial representation of the vehicle fleet and the connection path flow. The daisy chain connection is a connection where all the vehicles are connected to the next in a line or chain. The daisy chain connection is a connection where multiple vehicles are connected together in sequence or in a ring, similar to a garland of daisy flowers.

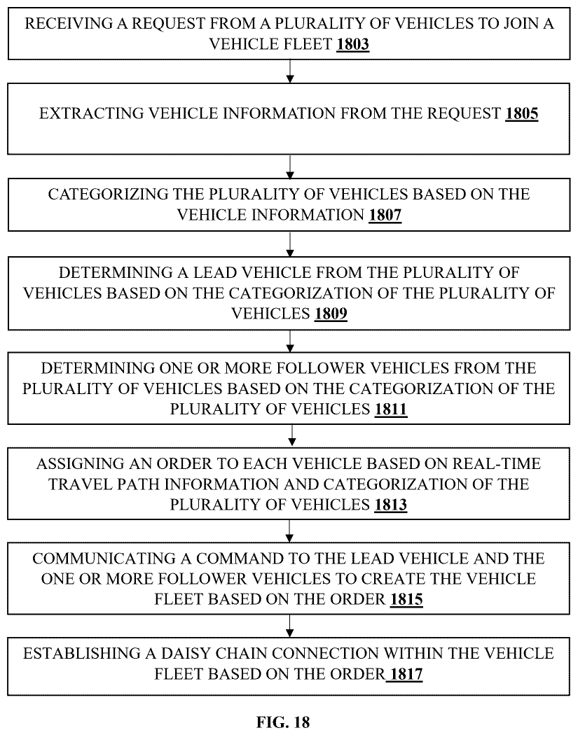

In another aspect, a method is described. As an example, FIG. 18 illustrates a method, according to one or more embodiments. The method comprises: receiving a request from a plurality of vehicles to join a vehicle fleet (at step 1803); extracting vehicle information from the request, wherein the vehicle information comprises at least one of a vehicle model, a vehicle make, a vehicle type, history of vehicle fleet, a vehicle identification number (ID), a vehicle color, a vehicle specification, and a vehicle service and maintenance history (at step 1805); categorizing the plurality of vehicles based on the vehicle information (at step 1807); determining a lead vehicle from the plurality of vehicles based on the categorization of the plurality of vehicles (at step 1809); determining one or more follower vehicles from the plurality of vehicles based on the categorization of the plurality of vehicles (at step 1811); assigning an order to each vehicle based on real-time travel path information and categorization of the plurality of vehicles (at step 1813); communicating a command to the lead vehicle and the one or more follower vehicles to create the vehicle fleet based on the order (at step 1815); and establishing a daisy chain connection within the vehicle fleet based on the order (at step 1817).

In one embodiment, the method further comprises: analyzing the request and identifying one or more keywords related to the vehicle information. The method further comprises determining one or more contents that comprises the vehicle information based on one or more keywords. The method further comprises categorizing the plurality of vehicles based on the vehicle information as at least one of a first grade, a second grade, and a third grade.

In one embodiment, the method further comprises: sorting the plurality of vehicles based on the vehicle information to assign the order. The method further comprises determining the lead vehicle and the one or more follower vehicles based on the sorting. In one embodiment, the method further comprises: determining a first vehicle as the lead vehicle when the first vehicle is in the first grade. In one embodiment, the method further comprises: determining one or more second vehicles as the one or more follower vehicles when the one or more second vehicles are in the second grade.

The method further comprises receiving the real-time travel path information from an external system. In one embodiment, the real-time travel path information comprises at least one of a traffic condition, a road surface condition, a road infrastructure, an environmental weather condition, road signs, and routing information. In another embodiment, the real-time travel path information is in at least one of a pictorial representation, and a textual representation.

The method further comprises mapping the road infrastructure with virtual place holders based on the real-time travel path information and the categorization of the plurality of vehicles. The method further comprises assigning the order to each vehicle of the plurality of vehicles in accordance with the virtual place holders based on the real-time travel path information and the categorization of the plurality of vehicles. The method further comprises assigning the order to each vehicle of the plurality of vehicles in accordance with the virtual place holders and to comply with safety based on the real-time travel path information and the categorization of the plurality of vehicles.

In another aspect, a non-transitory computer readable storage medium is described. As an example, FIG. 19 illustrates a non-transitory computer readable storage medium 1904, according to one or more embodiments. Computer system 1900 may comprise non-transitory computer readable storage medium 1904 and processor 1902. Non-transitory computer readable storage medium 1904 storing a sequence of instructions, which when executed, causes processor 1902 to: receiving a request from a plurality of vehicles to join a vehicle fleet (at step 1903); extracting vehicle information from the request, wherein the vehicle information comprises at least one of a vehicle model, a vehicle make, a vehicle type, history of vehicle fleet; a vehicle identification number (ID), a vehicle color, a vehicle specification, and a vehicle service and maintenance history (at step 1905); categorizing the plurality of vehicles based on the vehicle information (at step 1907); determining a lead vehicle from the plurality of vehicles based on the categorization of the plurality of vehicles (at step 1909); determining one or more follower vehicles from the plurality of vehicles based on the categorization of the plurality of vehicles (at step 1911); assigning an order to each vehicle based on real-time travel path information and categorization of the plurality of vehicles (at step 1913); communicating a command to the lead vehicle and the one or more follower vehicles to create the vehicle fleet based on the order (at step 1915); and establishing a daisy chain connection within the vehicle fleet based on the order (at step 1917).

The non-transitory computer readable storage medium further causes: analyzing the request and identifying one or more keywords related to the vehicle information. The non-transitory computer readable storage medium further causes: determining one or more contents that comprises the vehicle information based on the one or more keywords.

In one embodiment, the non-transitory computer readable storage medium further causes: categorizing the plurality of vehicles based on the vehicle information as at least one of a first grade, a second grade, and a third grade.

In one embodiment, the non-transitory computer readable storage medium further causes: sorting the plurality of vehicles based on the vehicle information to assign the order. The non-transitory computer readable storage medium further causes: determining the lead vehicle and the one or more follower vehicles based on the sorting. The non-transitory computer readable storage medium further causes: determining a first vehicle as the lead vehicle when the first vehicle is in the first grade. The non-transitory computer readable storage medium further causes: determining one or more second vehicles as the one or more follower vehicles when the one or more second vehicles are in the second grade.

In one embodiment, the non-transitory computer readable storage medium further causes: receiving the real-time travel path information from an external system. The real-time travel path information comprises at least one of a traffic condition, a road surface condition, a road infrastructure, an environmental weather condition, road signs, and routing information. In one embodiment, the real-time travel path information is in at least one of a pictorial representation, and a textual representation.

The non-transitory computer readable storage medium further causes: mapping the road infrastructure with virtual place holders based on the real-time travel path information and the categorization of the plurality of vehicles. The non-transitory computer readable storage medium further causes: assigning the order to each vehicle of the plurality of vehicles in accordance with the virtual place holders based on the real-time travel path information and the categorization of the plurality of vehicles. In one embodiment, the non-transitory computer readable storage medium further causes: assigning the order to each vehicle of the plurality of vehicles in accordance with the virtual place holders and to comply with safety based on the real-time travel path information and the categorization of the plurality of vehicles.

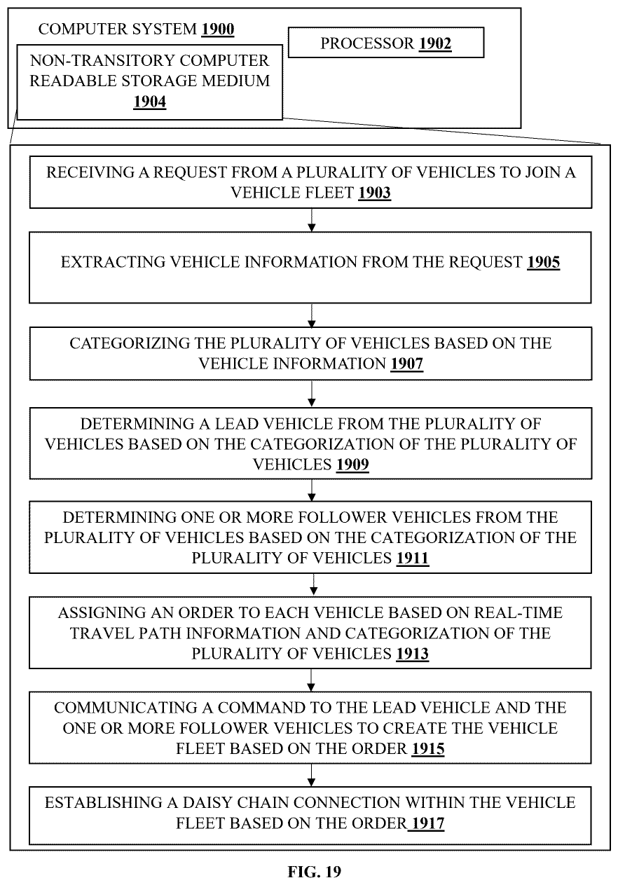

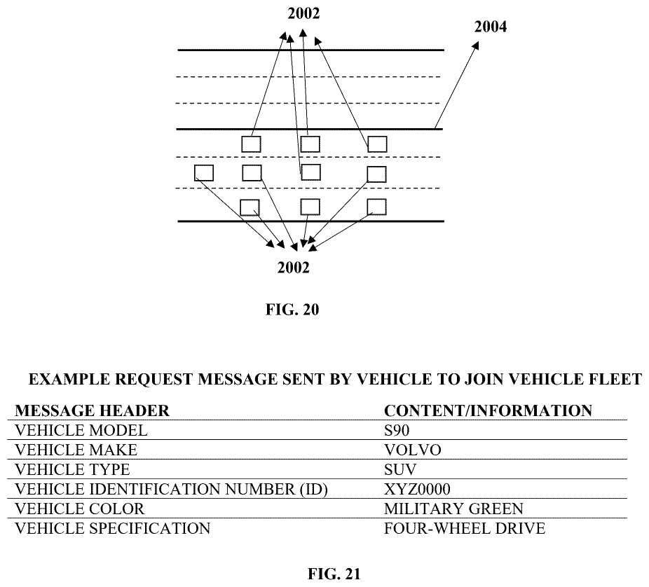

As an example, FIG. 20 illustrates a pictorial representation of the road infrastructure 2004 having virtual place holders 2002, according to one or more embodiments. The processor receives real-time travel path information from an external system. The real-time travel path information may be in one of pictorial representation and textual representation. The processor generates the pictorial representation of the road infrastructure 2004 based on the real-time travel path information received from the external system.

The processor depicts the pictorial representation of the road infrastructure 2004. The pictorial representation of the road infrastructure 2004 comprises lanes, bridges, bumps, etc. The processor generates the virtual place holders 2002 for each vehicle upon receiving the request to join the vehicle fleet. The processor accumulates the road infrastructure 2004 with virtual place holders 2002 for each vehicle joining the fleet. In one embodiment, the processor accumulates the road infrastructure 2004 with virtual place holders 2002 in accordance with the road infrastructure 2004 and the categorization of the vehicles. In one embodiment, the processor is operable to assign the order to each vehicle of the plurality of vehicles in accordance with the virtual place holders 2002 and to comply with safety based on the real-time travel path information and the categorization of the plurality of vehicles. The pictorial representation of the accumulation of the road infrastructure 2004 with the virtual place holders 2002 depicts the position for each vehicle on the vehicle fleet. The pictorial representation of the accumulation of the road infrastructure 2004 with the virtual place holders 2002 further depicts the connection to be established between the vehicles.

As an example, FIG. 21 illustrates a request message sent by vehicle, according to one or more embodiments. The request message comprises fields such as at least vehicle model, a vehicle make, a vehicle type; a vehicle identification number (ID), a vehicle color, a vehicle specification, etc.

The “vehicle identification number (ID)” may be a serial identification number associated with the vehicle to identify and recognize the vehicle. The “vehicle identification number (ID)” is a unique code, including a serial number, used by the automotive industry to identify individual motor vehicles. The “vehicle model” may be the specific name of the vehicle (e.g., S90). The “vehicle make” refers to the company that manufactured the vehicle (e.g., Volvo). The “vehicle type” refers to a type or category of the vehicle (e.g., sports utility vehicle (SUV)). The “vehicle color” refers to the color of the vehicle (e.g., Military Green). The “vehicle specification” refers to at least one feature of the vehicle (e.g., Manual Transmission, Advanced Driver Assistance System (ADAS), Four-wheel drive, etc.). The request message may also comprise any specific information that may impact the sorting of the vehicles and assigning the order to the vehicle in the vehicle fleet. The request message is just like an inquiry sent by the vehicles to the system requesting to join the vehicle fleet.

As an example, FIG. 22 illustrates a road infrastructure 2204 having vehicles 2202 arranged to form a vehicle fleet, according to one or more embodiments. The road infrastructure 2204 comprises one or more lanes. The processor allocates the vehicles 2202 as replacements for placeholders. The processor determines the real-world coordinates for each placeholder in the road infrastructure. The processor then communicates the real-world coordinates of respective placeholders to respective vehicles. The processor allocates the respective vehicles as replacements for placeholders.

The vehicles 2202 may be arranged with predefined distance between them. The predefined distance may be in a range of 10 to 100 meters. The processor allocates the vehicles 2202 based on the order assigned. The processor assigns the order to each vehicle in order to establish a connection (e.g., daisy chain connection) to establish communication between vehicles and to form a fleet. The lead vehicle may be given position in front of the vehicle fleet to direct the follower vehicles to the destination. In one embodiment, the lead vehicle may be given position in the middle of the vehicle fleet to instruct the follower vehicles till the destination. In another embodiment, the lead vehicle may be given the position of the last vehicle of the vehicle fleet to instruct the follower vehicles till the destination.

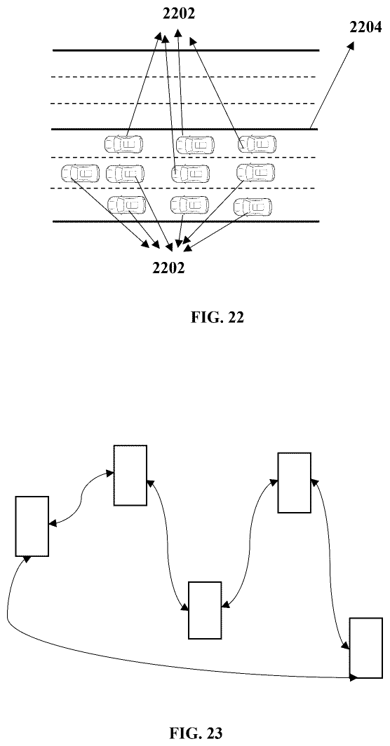

As an example, FIG. 23 illustrates a daisy chain connection, according to one or more embodiments. The daisy chain connection refers to a connection with multiple vehicles in a sequence, where each vehicle is connected to another vehicle. The daisy chain connection is used in establishing communications between the vehicles in such a manner as to organize and manage a vehicle fleet. The daisy chain connection enables the vehicle to communicate and follow the instructions communicated from the preceding vehicle. The daisy chain connection may function like a closed loop.

Among the vehicles connected in the daisy chain connection, the processor determines a vehicle as lead vehicle and the other vehicles as follower vehicles. The processor may communicate the routing path information message to the follower vehicles. The routing path information may be generated by the processor based on the information received from the request to join the vehicle fleet. The routing path information comprises information such as source, destination, traveling route, halt stops, halt location, predefined distance between vehicles, etc. Each vehicle may follow the instructions from the preceding vehicle and/or the lead vehicle. In an embodiment, each vehicle may follow its preceding vehicle. The preceding vehicle may communicate navigation directions to its succeeding vehicle. For example, when there is a right turn, the preceding vehicle communicates that there is a right turn to its succeeding vehicle before the succeeding vehicle reaches the right turn. The preceding vehicle communicates the navigation instructions in accordance with the road infrastructure. The preceding vehicle communicates the navigation instructions in accordance with vehicle safety.

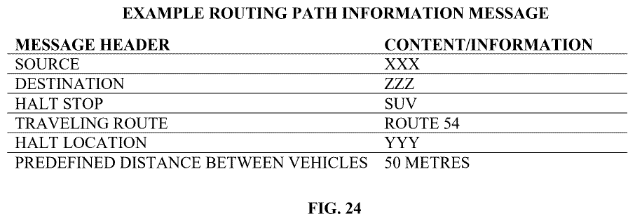

As an example, FIG. 24 illustrates a routing path information message, according to one or more embodiments. The routing path information message comprises fields such as source, destination, traveling route, halt stops, halt location, predefined distance between vehicles. The “source” may be a place or location from where the vehicle fleet journey starts or the common source where a vehicle joins the fleet journey. The “destination” may be a place or location from where the vehicle fleet journey ends. The “traveling route” may be a path or route through which the vehicle fleet is planned and to be executed. The “halt stop” refers to a number of halts or breaks scheduled for refreshment throughout the path. The “halt location” refers to a place or location for the halt or break. The “predefined distance between vehicles” refers to a distance to be maintained between the vehicles throughout the vehicle fleet. The routing path information message is just like a navigation message, though initiated by the processor to the vehicles.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising”, as “comprising” is interpreted when employed as a transitional word in a claim.

Other specific forms may embody the present invention without departing from its spirit or characteristics. The described embodiments are in all respects illustrative and not restrictive. Therefore, the appended claims rather than the description herein indicate the scope of the invention. All variations which come within the meaning and range of equivalency of the claims are within their scope.

1-49. (canceled)

50. A system comprising:
a processor storing instructions in non-transitory memory that, when executed, cause the processor to:
receive a request from a plurality of vehicles to join a vehicle fleet;
extract vehicle information from the request, wherein the vehicle information comprises at least one of a vehicle model, a vehicle make, a vehicle type, history of vehicle fleet, a vehicle identification number (ID), a vehicle color, and a vehicle service and maintenance history;
categorize the plurality of vehicles based on the vehicle information;
determine a lead vehicle from the plurality of vehicles based on the categorization of the plurality of vehicles;
determine one or more follower vehicles from the plurality of vehicles based on the categorization of the plurality of vehicles;
assign an order to each vehicle based on real-time travel path information and the categorization of the plurality of vehicles;
communicate a command to the lead vehicle and the one or more follower vehicles to create the vehicle fleet based on the order; and
establish a daisy chain connection within the vehicle fleet based on the order.

51. The system of claim 50, wherein the request is in a predefined format.

52. The system of claim 51, wherein the request is in a predefined message format.

53. The system of claim 50, wherein the processor comprises an artificial intelligence engine.

54. The system of claim 53, wherein the artificial intelligence engine analyzes the request and identifies one or more keywords related to the vehicle information.

55. The system of claim 54, wherein the artificial intelligence engine determines one or more contents that comprises the vehicle information based on the one or more keywords.

56. The system of claim 55, wherein the processor through the artificial intelligence engine extracts the vehicle information from the request.

57. The system of claim 50, wherein the processor categorizes the plurality of vehicles based on the vehicle information as at least one of a first grade, a second grade, and a third grade.

58. The system of claim 57, wherein the processor sorts the plurality of vehicles based on the vehicle information to assign the order.

59. The system of claim 58, wherein the processor determines the lead vehicle, and the one or more follower vehicles based on the sorting.

60. The system of claim 50, wherein the processor is operable to receive the real-time travel path information from an external system.

61. The system of claim 60, wherein the real-time travel path information comprises at least one of a traffic condition, a road surface condition, a road infrastructure, an environmental weather condition, road signs, and routing information.

62. The system of claim 61, wherein the processor is operable to map the road infrastructure with virtual place holders based on the real-time travel path information and the categorization of the plurality of vehicles.

63. The system of claim 62, wherein the processor is operable to assign the order to each vehicle of the plurality of vehicles in accordance with the virtual place holders based on the real-time travel path information and the categorization of the plurality of vehicles.

64. The system of claim 62, wherein the processor is operable to assign the order to each vehicle of the plurality of vehicles in accordance with the virtual place holders and to comply with safety based on the real-time travel path information and the categorization of the plurality of vehicles.

65. A method comprising:
receiving a request from a plurality of vehicles to join a vehicle fleet;
extracting vehicle information from the request, wherein the vehicle information comprises at least one of a vehicle model, a vehicle make, a vehicle type, history of vehicle fleet, a vehicle identification number (ID), a vehicle color, and a vehicle service and maintenance history;
categorizing the plurality of vehicles based on the vehicle information;
determining a lead vehicle from the plurality of vehicles based on the categorization of the plurality of vehicles;
determining one or more follower vehicles from the plurality of vehicles based on the categorization of the plurality of vehicles;
assigning an order to each vehicle based on real-time travel path information and categorization of the plurality of vehicles;
communicating a command to the lead vehicle and the one or more follower vehicles to create the vehicle fleet based on the order; and
establishing a daisy chain connection within the vehicle fleet based on the order.

66. The method of claim 65, wherein the method further comprises: receiving the real-time travel path information from an external system.

67. The method of claim 66, wherein the real-time travel path information is in at least one of a pictorial representation, and a textual representation.

68. A non-transitory computer readable storage medium storing a sequence of instructions, which when executed, causes a processor to:
receiving a request from a plurality of vehicles to join a vehicle fleet;
extracting vehicle information from the request, wherein the vehicle information comprises at least one of a vehicle model, a vehicle make, a vehicle type, history of vehicle fleet; a vehicle identification number (ID), a vehicle color, and a vehicle service and maintenance history;
categorizing the plurality of vehicles based on the vehicle information;
determining a lead vehicle from the plurality of vehicles based on the categorization of the plurality of vehicles;
determining one or more follower vehicles from the plurality of vehicles based on the categorization of the plurality of vehicles;
assigning an order to each vehicle based on real-time travel path information and categorization of the plurality of vehicles;
communicating a command to the lead vehicle and the one or more follower vehicles to create the vehicle fleet based on the order; and
establishing a daisy chain connection within the vehicle fleet based on the order.

69. The non-transitory computer readable storage medium of claim 68, further causes: categorizing the plurality of vehicles based on the vehicle information as at least one of a first grade, a second grade, and a third grade.
